(19) United States
(12) Patent Application Publication
(10) Pub. No.: US 2012/0311184 A1
(43) Pub. Date: Dec. 6, 2012

(54) IP Address Assignment System, Dynamic Host Configuration Protocol Server, And Method Of Assigning An IP Address

(75) Inventor: Daisuke YAMADA, Nagoya-shi (JP)

(73) Assignee: BUFFALO INC., Nagoya-shi (JP)

(21) Appl. No.: 13/483,831

(22) Filed: May 30, 2012

(30) Foreign Application Priority Data
May 31, 2011 (JP) 2011-121239

(51) Int. Cl. G06F 15/16

(52) U.S. Cl. 709/245

(57) ABSTRACT

A DHCP server assigning an IP address to a client. The DHCP server stores an exclusive address range corresponding to a range of IP addresses assignable to the client, assigns an IP address to the client with a lease period when a request for assignment of new IP address is received from the client, and sends a permission for extension to the client, irrespective of whether an assigned IP address is included in the exclusive address range, as long as the assigned IP address is included in the entire network address range, when a request for extension of the lease period with regard to the assigned IP address is received from the client.

### CROSS-REFERENCE TO RELATED APPLICATION

This application claims the benefit of priority under 35 U.S.C. §119 to Japanese Patent Application No. 2011-121239 filed on May 31, 2011, which is hereby incorporated by reference in its entirety and for all purposes.

### BACKGROUND

1. Technical Field

This disclosure relates to automatic assignment of IP addresses.

2. Related Art

In order to facilitate the setting of an IP address to a client connected with a network, a DHCP (Dynamic Host Configuration Protocol) server may be used. One proposed technique provides a plurality of DHCP server devices in an identical subnetwork (broadcast domain) to improve the redundancy. For example, according to one proposed method, two DHCP servers exchange information on the number of assigned IP addresses and the priorities, and the server having the less number of assigned IP addresses or the server with the higher priority functions as the DHCP server to respond to a request for assignment of IP address from a client.

According to this method, the two DHCP servers share an address pool, in order to prevent overlapped assignment of an IP address by the two DHCP servers (i.e., assignment of an identical IP address to a plurality of different clients). Two methods have been proposed to share the address pool of the same content. One method connects the two DHCP servers with one identical storage device storing the address pool, so as to make the two DHCP servers share the address pool of the same content. The other method provides the two DHCP servers including storage devices respectively storing the address pools and synchronizes data between the two storage devices, so as to make the two DHCP servers share the address pool of the same content.

### SUMMARY

According to one exemplary embodiment, the disclosure is directed to an IP address assignment system that assigns an IP address to a client. The IP address assignment system comprises a plurality of DHCP servers that respectively are able to belong to a first network. Each DHCP server includes an address range storage that stores an exclusive address range, wherein the exclusive address range represents a range of IP addresses assignable to the client in an entire network address range representing an overall IP address range of the first network, and the exclusive address range does not overlap with an exclusive address range of another DHCP server; an address assignment controller that assigns an IP address to the client with a lease period when a request for assignment of new IP address is received from the client, wherein the IP address is included in the exclusive address range and the lease period represents a period between an assignment of the IP address and a cancellation of the assignment; and an extension permission controller that sends a permission for extension to the client, irrespective of whether an assigned IP address is included in the exclusive address range, as long as the assigned IP address is included in the entire network address range, when a request for extension of the lease period with regard to the assigned IP address is received from the client.

According to another embodiment, the disclosure is directed to a DHCP server assigning an IP address to a client, the DHCP server being able to belong a first network. The DHCP server including an address range storage that stores an exclusive address range corresponding to a range of IP addresses assignable to the client in an entire network address range representing an overall IP address range of the first network, wherein the exclusive address range does not overlap with an exclusive address range of another DHCP server; an address assignment controller that assigns an IP address to the client with a lease period when a request for assignment of new IP address is received from the client, wherein the IP address is included in the exclusive address range and the lease period represents a period between an assignment of the IP address and a cancellation of the assignment; and an extension permission controller that sends a permission for extension to the client, irrespective of whether an assigned IP address is included in the exclusive address range, as long as the assigned IP address is included in the entire network address range, when a request for extension of the lease period with regard to the assigned IP address is received from the client.

According to another embodiment, the disclosure is directed to a method of assigning an IP address to a client using a plurality of DHCP servers that respectively are able to belong to a first network is provided. The method including assigning an IP address included in an exclusive address range to the client with a lease period representing a period between an assignment of the IP address and a cancellation of the assignment in each DHCP servers, when a request for assignment of new IP address is received from the client wherein the exclusive address range represents a range of IP addresses assignable to the client in an entire network address range representing an overall IP address range of the first network, and the exclusive address range does not overlap with an exclusive address range of another DHCP server; and sending a permission for extension to the client in each DHCP servers, irrespective of whether an assigned IP address is included in the exclusive address range, as long as the assigned IP address is included in the entire network address range, when a request for extension of the lease period with regard to the assigned IP address is received from the client.

According to another embodiment, the disclosure is directed to a method of assigning an IP address to a client using a DHCP server that is able to belong to a first network is provided. The method including assigning an IP address included in an exclusive address range to the client with a lease period representing a period between an assignment of the IP address and a cancellation of the assignment in a DHCP server, when a request for assignment of new IP address is received from the client wherein the exclusive address range represents a range of IP addresses assignable to the client in an entire network address range representing an overall IP address range of the first network, and the exclusive address range does not overlap with an exclusive address range of another DHCP server; and sending a permission for extension to the client in a DHCP server, irrespective of whether an assigned IP address is included in the exclusive address range, as long as the assigned IP address is included in the entire network address range, when a request for extension of the lease period with regard to the assigned IP address is received from the client.

### BRIEF DESCRIPTION OF THE DRAWINGS

FIG. 1 illustrates the schematic configuration of an IP address assignment system 10 according to one embodiment of the disclosure;

FIG. 2 illustrates a second connection configuration of the IP address assignment system 10;

FIG. 3 illustrates a third connection configuration of the IP address assignment system 10;

FIG. 4 illustrates the detailed structure of the portable network connection device 20;

FIG. 5 illustrates the detailed structure of the router 500;

FIG. 6 is a flowchart showing the procedure of operation mode changeover process according to the first embodiment;

FIG. 7 is a flowchart showing the procedure of DHCP server arbitration process performed in the IP address assignment system 10;

FIG. 8 is a sequence diagram showing the procedure of address range adjustment process performed in the IP address assignment system 10;

FIG. 9 schematically shows an example of the settings of an address management table stored in the address management table storage module 342 of the router 500 shown in FIG. 5;

FIG. 10 is a flowchart showing the procedure of DHCP server process performed by the router 500 and the portable network connection device 20 (main unit 100);

FIG. 11 is a first view illustrating an example of the DHCP server process;

FIG. 12 is a second view illustrating another example of the DHCP server process;

FIG. 13 illustrates the detailed structure of a portable network connection device 20a according to a second embodiment;

FIG. 14 illustrates the detailed structure of a router 500a according to the second embodiment;

FIG. 15 illustrates a first connection configuration of the second embodiment;

FIG. 16 is a flowchart showing the procedure of DHCP server arbitration process according to the second embodiment;

FIG. 17 is a sequence diagram showing the procedure of address range adjustment process according to the second embodiment;

FIG. 18 illustrates the detailed structure of a portable network connection device according to a third embodiment;

FIG. 19 illustrates the detailed structure of a router 500b according to the third embodiment;

FIG. 20 is a flowchart showing the procedure of DHCP server arbitration process according to the third embodiment; and

FIG. 21 is a sequence diagram showing the procedure of address range adjustment process according to the third embodiment.

### DESCRIPTION OF EMBODIMENTS

### A. First Embodiment

A1. System Configuration

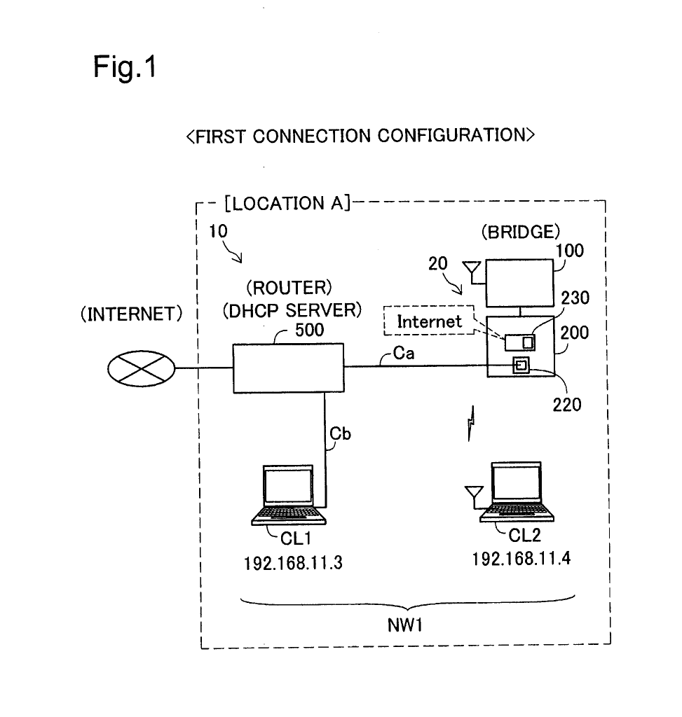

FIG. 1 illustrates the schematic configuration of an IP address assignment system 10 according to one embodiment of the disclosure. The IP address assignment system 10 of the first embodiment includes a router 500, a portable network connection device 20, a first client CL1 and a second client CL2. The number of clients is not limited to two but may be any number. The system 10 may be used in, for example, home or small office. The IP address assignment system 10 serves to assign an IP address to each client belonging to the system (in the illustrated example of FIG. 1, each of the two clients CL1 and CL2) and relay packets (layer 3 packets and layer 2 frames), so as to enable communication between the clients or communication via the Internet.

The router 500 is a device configured to relay packets on layer 3 (third layer of OSI reference model) and is connected to the Internet. The router 500 is connected with a cradle 200 by a network cable Ca and with the first client CL1 by a network cable Cb. The router 500 is a stationary device. The router 500 may be provided, for example, as a home gateway by an ISP (Internet Service Provider). The detailed structure of the router 500 will be described later.

The portable network connection device 20 includes a main unit 100 and a cradle 200 that are removably connectable with each other. The main unit 100 is a small, lightweight portable device serving to relay packets (frames) on layer 3 or layer 2. In the configuration of FIG. 1, the main unit 100 is connected with the cradle 200. In the configuration of FIG. 1, the main unit 100 is also connected with the first client CL1 by the network cable Ca and with the second client CL2 by wireless. The main unit 100 has an operation mode for relaying packets on layer 3 (i.e., operation mode working as the router) and an operation mode for relaying packets on layer 2 (i.e., operation mode working as the bridge). In the illustrated example of FIG. 1, the main unit 100 serves as the bridge. The detailed structure of the portable network connection device 20 will be described later.

The cradle 200 provides the main unit 100 with various functions, when being connected with the main unit 100. The cradle 200 serves as a base stand, on which the main unit 100 is placed, and as a battery charger. The cradle 200 has a port 220 and a changeover switch 230. The port 220 is used to connect the main unit 100 to a wired LAN via the cradle 200 and is connected with the network cable Ca. The changeover switch 230 is a slide switch to be manually changed between an “Internet” position and a “Lan” position. In the configuration of FIG. 1, the changeover switch 230 is set to the “Internet” position.

The two clients CL1 and CL2 are both personal computers. The first client CL1 has a wired LAN interface and is connected with the router 500 via the wired LAN interface and the network cable Cb. The second client CL2 has a wireless LAN interface and is connected with the main unit 100 via the wireless LAN interface. In the configuration of FIG. 1, the main unit 100 serves as a wireless LAN access point, and the second client CL2 serves as a wireless LAN client.

The IP address assignment system 10 allows a plurality of connection configurations among its constituents. FIG. 1 shows a first connection configuration of the IP address assignment system 10. In the first connection configuration, all the constituents are provided at one identical location A (e.g., home or office). In the first connection configuration, one network NW1 is formed in the downstream of the router 500 (i.e., on the side farther away from the Internet). The “network” according to the first embodiment represents coverage of broadcast frames and means a range, in which IP addresses of the same network address are assigned. In the first connection configuration, the router 500 serves as a DHCP (Dynamic Host Configuration Protocol) server to assign IP addresses to the respective clients CL1 and CL2. More specifically, according to the first embodiment, the router 500 assigns an IP address “192.168.11.3” to the first client CL1 and an IP address “192.168.11.4” to the second client CL2. These IP addresses are private IP addresses, and the router 500 converts between the private IP address and the global IP address when each of the clients CL1 and CL2 communicates via the Internet. In the first connection configuration, the main unit 100 does not work as the DHCP server.

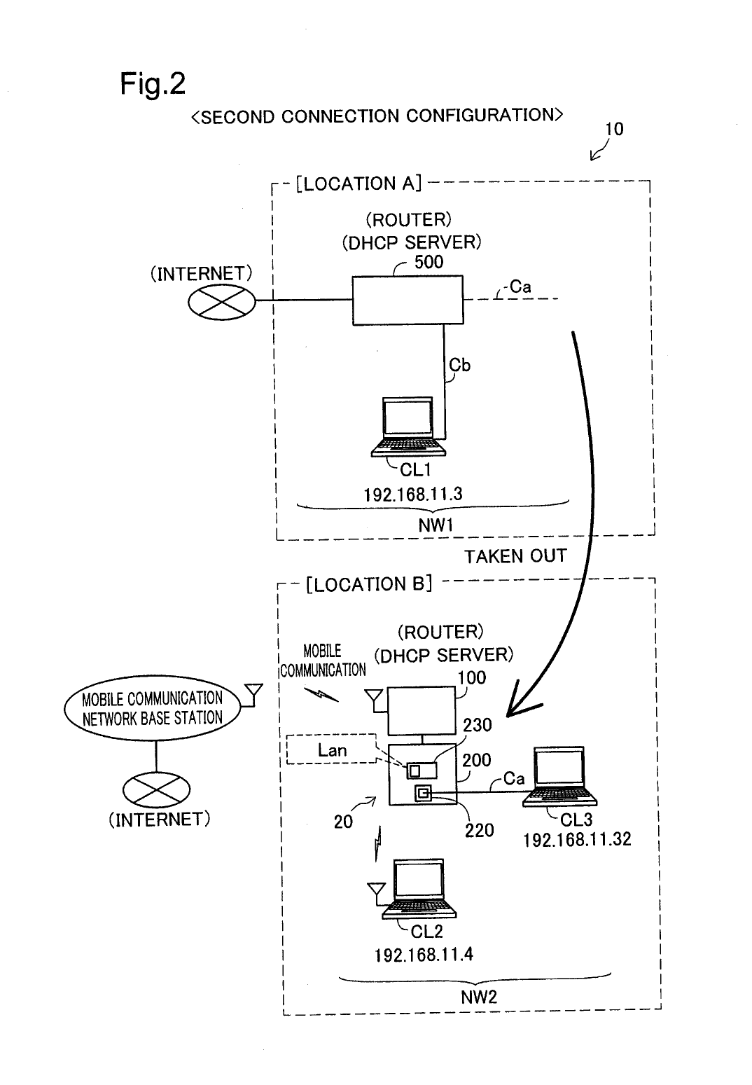

FIG. 2 illustrates a second connection configuration of the IP address assignment system 10. In the second connection configuration, all the constituents are not provided at one identical location. More specifically, the router 500, the first client CL1 and the network cable Cb are provided at a location A shown in the upper half of FIG. 2. The main unit 100, the cradle 200, the second client CL2, a third client CL3 and the network cable Ca are provided at a location B shown in the lower half of FIG. 2. In the second connection configuration of the first embodiment, the location A and the location B are significantly remote from each other. For example, the location A and location B are remote from each other, such that communication between a wireless LAN access point at one location and a wireless LAN client at the other location is not allowed.

The third client CL3 is a personal computer like the two clients CL1 and CL2 and has a wired LAN interface. The third client CL3 is connected with the main unit 100 via the wired LAN interface, the network cable Ca and the cradle 200. In the second connection configuration, the changeover switch 230 is set to the “Lan” position.

The main unit 100 has a mobile communication interface and establishes wireless communication with a mobile communication network base station via the mobile communication interface.

The first connection configuration of FIG. 1 at the location A may be changed to the second connection configuration of FIG. 2, for example, when the user detaches the network cable Ca from the router 500, takes out the main unit 100, the cradle 200 and the second client CL2 to the location B, and connects the third client CL3 as a new client with the network cable Ca at the location B. The user may take out the main unit 100 and the other constituents from the location A, for example, when the user takes out the second client CL2 to the location B with maintaining the communication via the Internet. As shown in FIG. 2, a new network NW2 is formed at the location B. The same network addresses (private addresses) as those in the network NW1 are used in the network NW2. Broadcast frames are, however, not received and transmitted between these two networks NW1 and NW2.

At the location B, the main unit 100 works as the DHCP server. The main unit 100 assigns an IP address “192.168.11.32” to the third client CL3 newly joining the IP address assignment system 10 at the location B. At the location B, the main unit 100 also works as the router. More specifically, the main unit 100 serves to relay an IP packet output from either the second client CL2 or the third client CL3 to a mobile communication network and to relay an IP packet addressed to the second client CL2 or the third client CL3 received from the mobile communication network to the second client CL2 or the third client CL3.

In the second connection configuration, the location A has the similar configuration to the first connection configuration, except the main unit 100, the cradle 200 and the second client CL2 are taken out of the location A. More specifically, the first client CL1 is connected with the router 500 by the network cable Cb to communicate via the Internet through the router 500.

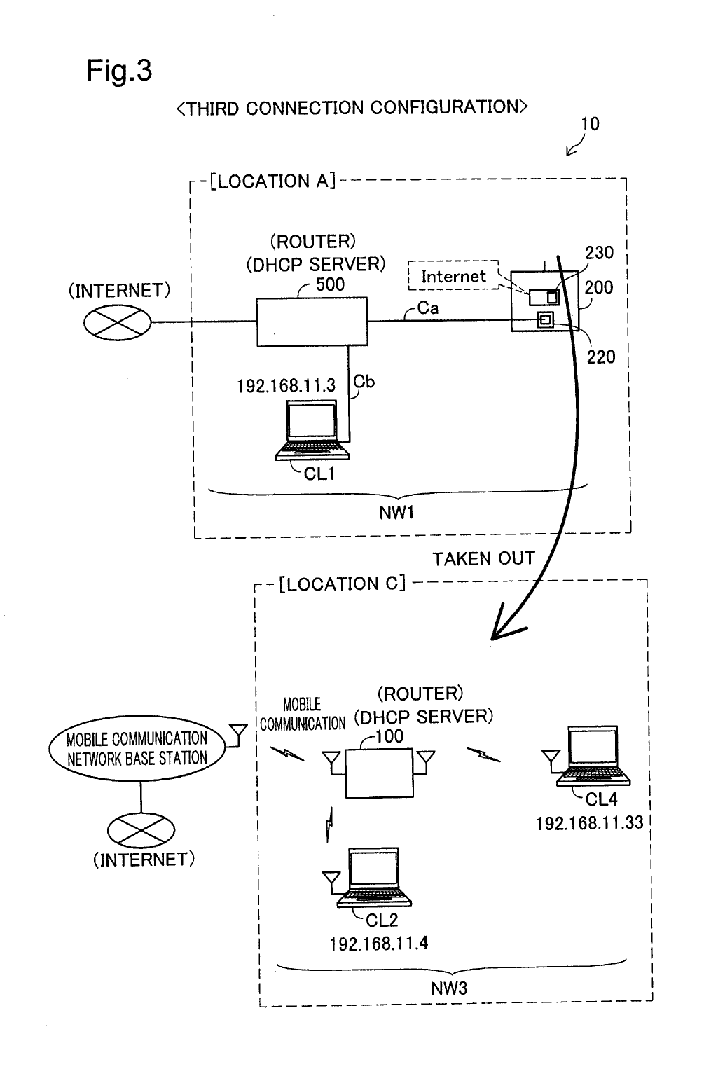

FIG. 3 illustrates a third connection configuration of the IP address assignment system 10. As in the second network configuration, in the third network configuration, all the constituents are not provided at one identical location. More specifically, the router 500, the cradle 200, the first client CL1, the network cable Ca and the network cable Cb are provided at a location A shown in the upper half of FIG. 3. The main unit 100, the second client CL2 and a fourth client CL4 are provided at a location C shown in the lower half of FIG. 3. In the third connection configuration of the first embodiment, the location A and the location C are significantly remote from each other. For example, the location A and location C are remote from each other, such that communication between a wireless LAN access point at one location and a wireless LAN client at the other location is not allowed.

The fourth client CL4 is a personal computer like the two clients CL1 and CL2 and has a wireless LAN interface. The fourth client CL4 is connected with the main unit 100 via the wireless LAN interface. In the third connection configuration, the changeover switch 230 is set to the “Internet” position.

The first connection configuration of FIG. 1 at the location A may be changed to the third connection configuration of FIG. 3, for example, when the user separates the main unit 100 from the cradle 200, takes out the main unit 100 and the second client CL2 to the location C, and connects the fourth client CL4 as a new client with the main unit 100 serving as the wireless LAN access point by wireless communication at the location C. The user may take out the main unit 100 and the second client CL2 from the location A, for example, when the user takes out the second client CL2 to the location C with maintaining the communication via the Internet, as in the second connection configuration. As shown in FIG. 3, a new network NW3 is formed at the location C. The same network addresses as those in the network NW1 are used in the network NW3. Broadcast frames are, however, not received and transmitted between these two networks NW1 and NW3.

At the location C, the main unit 100 works as the DHCP server. The main unit 100 assigns an IP address “192.168.11.33” to the fourth client CL4 newly joining the IP address assignment system 10 at the location C. At the location C, the main unit 100 also works as the router. More specifically, the main unit 100 serves to relay an IP packet output from either the second client CL2 or the fourth client CL4 to a mobile communication network and to relay an IP packet addressed to the second client CL2 or the fourth client CL4 received from the mobile communication network to the second client CL2 or the fourth client CL4.

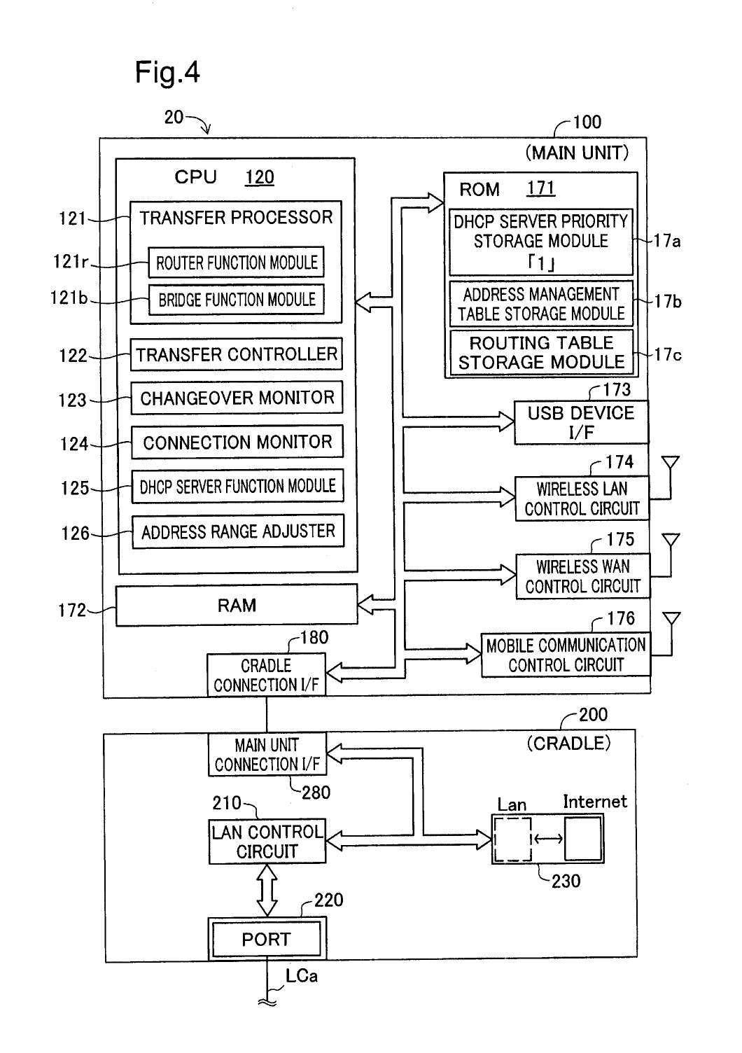

FIG. 4 illustrates the detailed structure of the portable network connection device 20. The cradle 200 includes a main unit connection interface (I/F) 280 and a LAN control circuit 210, in addition to the port 220 and the changeover switch 230 described above. The port 220 may be, for example, a port conforming to the IEEE802.3/3u/3ab standard. The LAN control circuit 210 controls data transmission via the port 220 according to a predetermined network protocol (for example, Ethernet (registered trademark)).

The changeover switch 230 is used to change over the function of the port 220 and is located near the port 220. The port 220 serves as the port for connecting with the client at the “Lan” position of the changeover switch 230, while serving as the port for connecting with another device different from the client at the “Internet” position of the changeover switch 230. The “client” herein means a device that terminates communication on relatively upper layer (for example, layer 4 or upper layer), whilst the “device different from the client” herein means a device that terminates communication on relatively lower layer (for example, layer 3 or lower layer) and relays data (packets) to the client, such as a layer 2 switch, a layer 3 switch or a router. The “relatively lower layer” represents the layer lower than the “relatively upper layer”.

The main unit connection interface 280 has the functions of a USB (Universal Serial Bus) device controller. The main unit connection interface 280 serves to transmit information to and from the main unit 100 according to the USB standards and supply electric power to the main unit 100 when the cradle 200 is connected with the main unit 100.

As shown in FIG. 4, the main unit 100 includes a CPU 120, a ROM 171, a RAM 172, a USB device interface (I/F) 173 for connecting with a USB device, a wireless LAN control circuit 174, a wireless WAN control circuit 175, a mobile communication control circuit 176 and a cradle connection interface (I/F) 180 for connecting with the cradle 200.

The wireless LAN control circuit (also called “wireless LAN interface”) 174 includes a modulator, an amplifier and an antenna. The wireless LAN control circuit 174 serves as a wireless LAN access point conforming to, for example, the IEEE802.11b/g standard to establish wireless communication with a wireless LAN client (e.g., personal computer or game machine). The wireless WAN control circuit (also called “wireless WAN interface”) 175 includes a modulator, an amplifier and an antenna. The wireless WAN control circuit 175 serves as a wireless LAN client conforming to, for example, the IEEE802.11a/b/g standard to establish wireless communication with a wireless LAN access point (e.g., public wireless LAN access point). The mobile communication control circuit (also called “mobile communication interface”) 176 includes a modulator, an amplifier and an antenna. The mobile communication control circuit 176 serves as a mobile communication terminal conforming to, for example, the 3G/HSPA protocol to establish wireless communication with a mobile communication network base station. As described, the main unit 100 of the first embodiment has a plurality of wireless communication interfaces for making wireless communication in different wireless communication networks.

The cradle connection interface 180 has the functions of a USB host controller and serves to transmit information to and from the cradle 200 according to the USB standards when the main unit 100 is connected with the cradle 200. The cradle connection interface 180 also serves to feed the electric power supplied from the cradle 200 via the main unit connection interface 280 to a battery provided in the main unit 100 when the main unit 100 is connected with the cradle 200.

The CPU 120 loads and executes computer programs stored in the ROM 171 onto the RAM 172, so as to control the respective components of the portable network connection device 20. The CPU 120 controlling the respective components of the portable network connection device 20 to serve as various functional blocks, i.e., a transfer processor 121, a transfer controller 122, a changeover monitor 123, a connection monitor 124, a DHCP server function module 125 and an address range adjuster 126.

The transfer processor 121 has a router function module 121r and a bridge function module 121b. The transfer processor 121 serves to forward packets (layer 3 packets and layer 2 frames) input via the respective wireless communication interfaces (wireless LAN control circuit 174, wireless WAN control circuit 175 and mobile communication control circuit 176) and the port 220 of the cradle 200 to destination addresses. The transfer controller 122 controls the transfer processor 121. As one of such controls, the transfer controller 122 performs an operation mode changeover process (described later) to set or change the operation mode of the transfer processor 121.

The changeover monitor 123 monitors the setting of the changeover switch 230. More specifically, for example, the changeover switch 230 is connected with a GPIO (General Purpose Input/Output) port of the CPU 120 by a control line, and the changeover monitor 123 monitors the setting of the changeover switch 230 by an interrupt signal input into the CPU 120 via the control line.

The connection monitor 124 is the functional block to monitor whether the main unit 100 is connected with the cradle 200. Such monitoring may be based on, for example, power supply or no power supply between the main unit connection interface 280 and the cradle connection interface 180. In another example, the connection or disconnection between the main unit 100 and the cradle 200 may be monitored according to a connection detection sequence between the devices conforming to the USB standard (for example, connection is detected when either D+ or D− is equal to 3.3 V).

The DHCP server function module 125 provides the client with the DHCP services. More specifically, for example, the DHCP server function module 125 specifies an IP address to be assigned to a client, in response to a request for assignment of new IP address from the client, and notifies the client of the newly assigned IP address. The ECHP server function module 125 also determines the permission or refusal of extension, in response to a request for extension of the lease period of an IP address from a client, and notifies the client of the determination result.

The address range adjuster 126 makes adjustment with the router 500 for the IP address pool assignable to the client by the DHCP server function module 125.

The ROM 171 is a flash ROM and is a writable memory. The ROM 171 stores a DHCP server priority storage module 17a, an address management table storage module 17b and a routing table storage module 17c, in addition to the programs for the respective functional blocks described above.

The DHCP server priority storage module 17a stores a DHCP server priority. According to the first embodiment, the “DHCP server priority” is a parameter representing the priority working as the DHCP server among a plurality of devices operable as the DHCP server. According to the first embodiment, the value “1” is set (stored) in advance as the DHCP server priority in the DHCP server priority storage module 17a of the main unit 100. The DHCP server priority is used in a DHCP server arbitration process described later. The address management table storage module 17b stores a table for recording the address pool. In this table, each assigned IP address is recorded in correlation to information on a MAC address of the client, to which the IP address was assigned, the time when the IP address was assigned, and the lease period of the assigned IP address. The routing table storage module 17c stores a routing table.

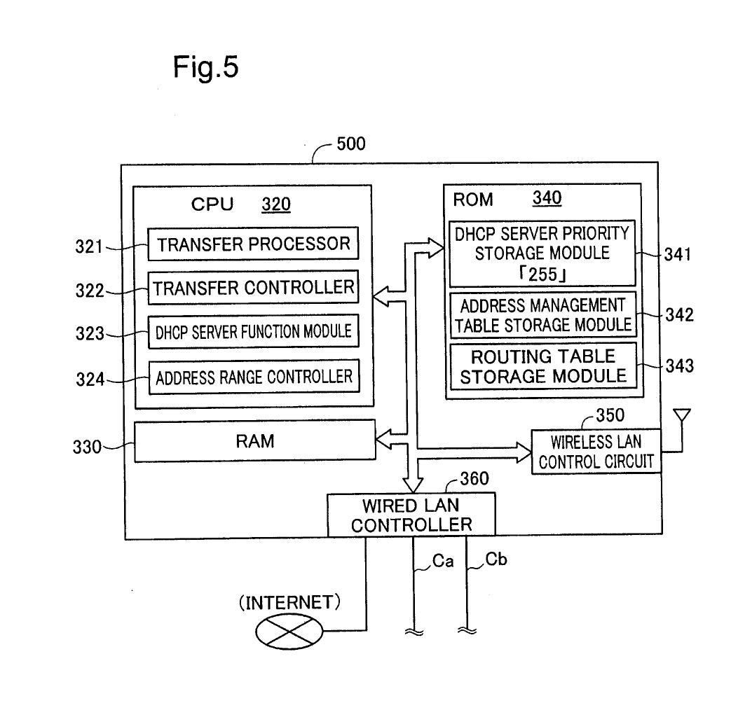

FIG. 5 illustrates the detailed structure of the router 500. The router 500 includes a CPU 330, a ROM 340, a wireless LAN control circuit 350 and a wired LAN controller 360.

The CPU 320 loads an executes computer programs stored in the ROM 340 onto the RAM 330 to serve as various functional blocks, i.e., a transfer processor 321, a transfer controller 322, a DHCP server function module 323 and an address range controller 324.

The transfer processor 321 forwards an IP packet input via the wired LAN controller 360 or the wireless LAN control circuit 350 to a destination address. The transfer controller 322 controls the transfer processor 321. The DHCP server function module 323 provides the client with the DHCP services, like the DHCP server function module 125 of the main unit 100 shown in FIG. 4. The address range controller 324 determines the address pool assignable to the client by the router 500 (i.e., DHCP server function module 323) and the address pool assignable to the client by the main unit 100 (i.e., DHCP server function module 125).

The ROM 340 is a flash ROM and is a writable memory. The ROM 340 stores a DHCP server priority storage module 341, an address management table storage module 342 and a routing table storage module 343, in addition to the programs for the respective functional blocks described above.

Like the DHCP server priority storage module 17a of the main unit 100 shown in FIG. 4, the DHCP server priority storage module 341 stores a DHCP server priority. According to the first embodiment, the value “255” is set (stored) in advance as the DHCP server priority in the DHCP server priority storage module 341 of the router 500. Like the address management table storage module 17b of the main unit 100 shown in FIG. 4, the address management table storage module 342 stores a table for recording the address pool. Like the routing table storage module 17c of the main unit 100 shown in FIG. 4, the routing table storage module 343 stores a routing table.

The wireless LAN control circuit 350 has the similar structure to that of the wireless LAN control circuit 174 of the main unit 100 shown in FIG. 4. The wired LAN controller 360 has a plurality of ports. The wired LAN controller 360 is connected with the first client CL1 and the second client CL2 via cables linked with these ports (e.g., network cable Ca and network cable Cb), and is also connected to the Internet. The wired LAN controller 360 controls data transmission via the port according to a predetermined network protocol (for example, Ethernet (registered trademark)).

The address management table storage modules 17b and 342 respectively correspond to the address range storage unit described above. The router 500 and the main unit 100 correspond to the plurality of DHCP servers described above; the DHCP server function module 125 corresponds to the address assignment controller, the extension permission controller and the DHCP server function arbiter described above; the DHCP server function module 323 corresponds to the address assignment controller, the extension permission controller and the DHCP server function arbiter described above; the network NW1 corresponds to the first network described above; the networks NW2 and NW3 correspond to the second network described above; the address range adjuster 126 corresponds to the exclusive address range assignment request sender described above; and the address range controller 323 corresponds to address range setting module described above. Among the various functions implemented by the DHCP server function modules 125 and 323, the function of specifying an IP address to be assigned to a client in response to a request for assignment of new IP address from the client and notifying the client of the newly assigned IP address and the function of determining the permission or refusal of extension in response to a request for extension of the lease period of an IP address from a client and notifying the client of the determination result correspond to the DHCP server function described above.

A2. Operation Mode Changeover Process

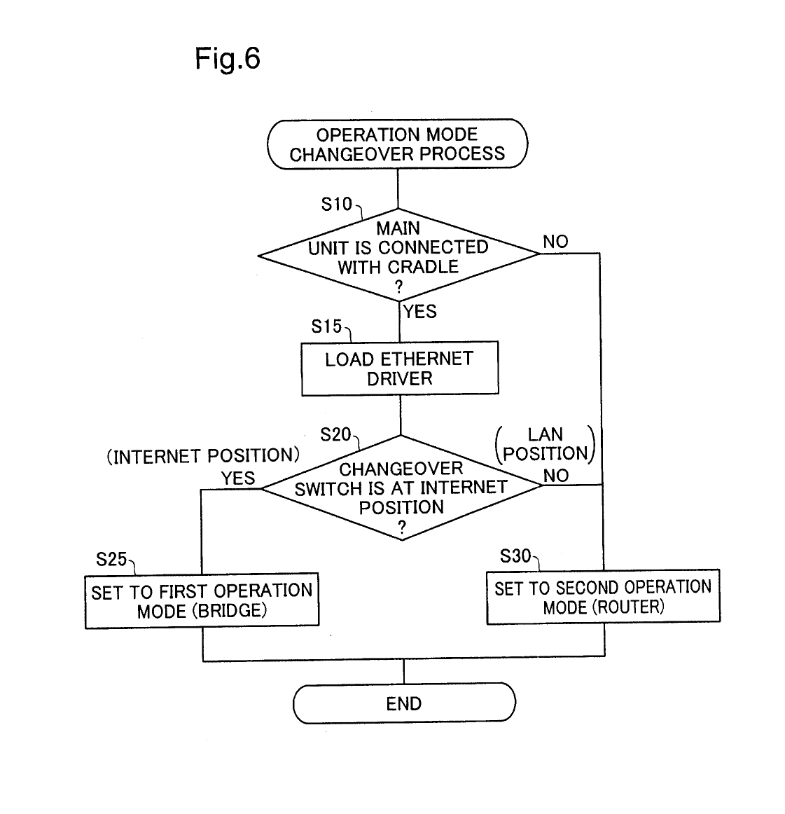

FIG. 6 is a flowchart showing the procedure of operation mode changeover process according to the first embodiment. In the IP address assignment system 10 of the first embodiment, the portable network connection device 20 performs the operation mode changeover process to determine and change the operation mode of the portable network connection device 29 (transfer processor 121). More specifically, in the portable network connection device 20, the connection monitor 124 continuously monitors the connection or disconnection between the main unit 100 and the cradle 200, after the portable network connection device 20 is powered ON. The changeover monitor 123 continuously monitors the change in setting (operation or no operation) of the changeover switch 230, after the portable network connection device 20 is powered ON. In the portable network connection device 20, the operation mode changeover process is triggered by a change in connection state between the main unit 100 and the cradle 200 or by a change in setting of the changeover switch 230.

The transfer controller 122 first controls the connection monitor 124 to determine whether the main unit 100 is connected with the cradle 200 (step S10). When the main unit 100 is connected with the cradle 200 (step S10: Yes), the transfer controller 122 loads an Ethernet (registered trademark) driver program stored in the ROM 171, onto the LAN control circuit 210 of the cradle 200 (step S15).

The transfer controller 122 then controls the changeover monitor 123 to determine whether the changeover switch 230 is set at the “Internet” position (step S20). When the changeover switch 230 is set at the “Internet” position (step S20: Yes), the transfer controller 122 sets or changes the operation mode of the transfer processor 121 to a first operation mode (step S25). When the changeover switch 230 is set at the “Lan” position (step S20: No), on the other hand, the transfer controller 122 sets or changes the operation mode of the transfer processor 121 to a second operation mode (step S30). According to the first embodiment, the first operation mode means the operation mode serving as the bridge, and the second operation mode means the operation mode serving as the router.

When the main unit 100 is connected with the cradle 200 (step S10: Yes) and the changeover switch 230 is set at the “Internet” position (step S20: Yes), it is estimated that the router 500 is connected with the main unit 100 via the cradle 200 (i.e., first connection configuration shown in FIG. 1). In this case, the router 500 works as the device to relay IP packets, so that the portable network connection device 20 is set to work in the first operation mode serving as the bridge (step S25) according to the first embodiment. When the main unit 100 is connected with the cradle 200 (step S10: Yes) and the changeover switch 230 is set at the “Lan” position (step S20: No), on the other hand, it is estimated that a client is connected with the cradle 200 and that the main unit 100 is not connected with the router 500 (i.e., second connection configuration shown in FIG. 2). In this case, it is estimated that there is no device to relay IP packets (i.e., router) at the location where the portable network connection device 20 is placed (e.g., location B shown in FIG. 2). According to the first embodiment, the portable network connection device 20 (transfer processor 121) is accordingly set to work in the second operation mode serving as the router (step S30). When the main unit 100 is disconnected from the cradle 200 (step S10: No), the third connection configuration is estimated. According to the first embodiment, the portable network connection device 20 (main unit 100) is accordingly set to work in the second operation mode serving as the router (step S30).

A3. DHCP Server Arbitration Process

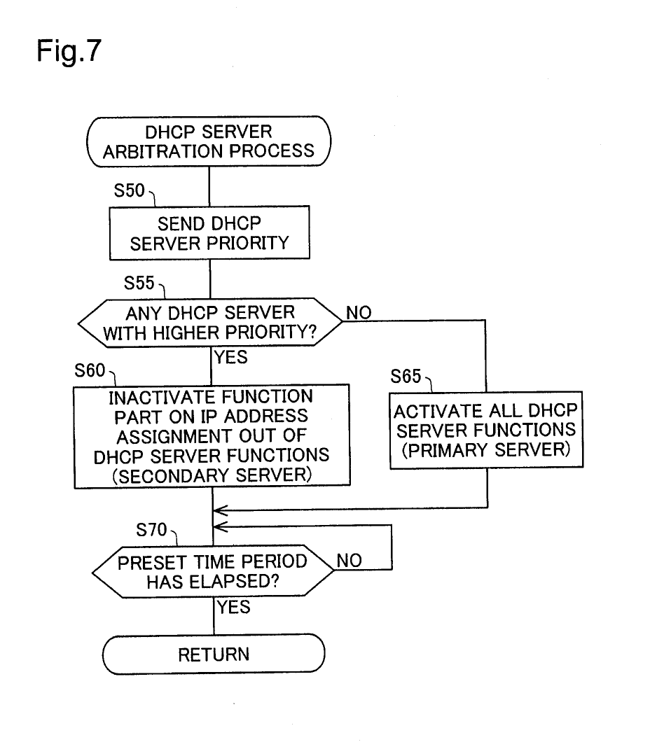

FIG. 7 is a flowchart showing the procedure of DHCP server arbitration process performed in the IP address assignment system 10. In the IP address assignment system 10 of the first embodiment, after the router 500 and the main unit 100 are powered ON, the DHCP server arbitration process is performed by the router 500 and the main unit 100 at regular intervals to determine one device working as the DHCP server in the same network (broadcast domain).

With referring to FIGS. 4 and 7, an exemplary flow of the DHCP server arbitration process performed by the main unit 100 of the portable network connection device 20 is described. The DHCP server function module 323 of the router 500 performs the same series of processing.

The DHCP server function module 125 of the main unit 100 reads the DHCP server priority stored in the DHCP server priority storage module 17a and broadcasts the DHCP server priority to the network (step S50). Since the value “1” is stored in the DHCP server priority storage module 17a of the main unit 100 as shown in FIG. 4, the DHCP server function module 125 broadcasts this DHCP server priority “1”. The broadcast may utilize a vendor specific area of a DHCP message “DHCPINFORM”.

The DHCP server function module 125 determines whether there is any DHCP server with the higher DHCP server priority than the own DHCP server priority (step S55). In the first connection configuration of FIG. 1, the main unit 100 receives the DHCP server priority “255” broadcasted by the router 500. The DHCP server function module 125 of the main unit 100 compares the received DHCP server priority “255” with the own DHCP server priority “1” and determines that there is a DHCP server with the higher DHCP server priority. In the second connection configuration of FIG. 2 or in the third connection configuration of FIG. 3, on the other hand, the main unit 100 does not belong to the same network (broadcast domain), which the router 500 belongs to and accordingly does not receive the DHCP server priority “255” broadcasted by the router 500. In this case, since the main unit 100 does not receive any DHCP server priority as the target for comparison, the DHCP server function module 125 of the main unit 100 determines that there is no DHCP server with the higher DHCP server priority.

When it is determined that there is no DHCP server with the higher DHCP server priority than the own DHCP server priority (step S55: No), the DHCP server function module 125 of the main unit 100 activates all the DHCP server functions (step S65), in order to enable, for example, the following operations. When receiving a request for assignment of new IP address from a client, the main unit 100 determines an IP address in the assignable address pool set in the main unit 100 and assigns the determined IP address to the client. When receiving a request for extension of the lease period from a client, to which an IP address has already been assigned, the main unit 100 determines the permission or refusal of extension and notifies the client of the determination result. When the main unit 100 is powered on, the DHCP server function module 125 starts the operations to activate all the DHCP server functions. In this case, the processing of step S65 maintains the active state of all the DHCP server functions. In the IP address assignment system 10, the device that is capable of implementing the DHCP server functions and has actually activated all the DHCP server functions is hereinafter called “primary server”.

When it is determined that there is any DHCP server with the higher DHCP server priority than the own DHCP server priority (step S55: Yes), on the other hand, the DHCP server function module 125 of the main unit 100 inactivates the function part on IP address assignment out of the DHCP server functions (step S60). The function part on IP address assignment means the function of determining an IP address in the own assignable address pool and assigning the determined IP address to the client, when a request for assignment of new IP address is received from the client, and means the function of determining the permission or refusal of extension and notifying the client of the determination result, when a request for extension of the lease period is received from the client, to which an IP address has already been assigned. In the IP address assignment system 10, the device that is capable of implementing the DHCP server functions but has inactivated the function part on IP address assignment out of the DHCP server functions is hereinafter called “secondary server”. Even when the device is set to work as the secondary server at step S60, the other DHCP server functions but the function part on IP address assignment (for example, the function of performing the DHCP server arbitration process) are kept active.

After either step S60 or step S65, the DHCP server function module 125 of the main unit 100 waits for elapse of a preset time period (step S70) and repeats the processing of steps S50 to S60 (or S65).

In the first connection configuration of FIG. 1, the router 500 and the main unit 100 are both notified of the DHCP server priority of the other. The router 500 accordingly works as the primary server, and the main unit 100 works as the secondary server. When the user takes out the portable network connection device 20 and some other constituents from the location A to the location B to change from the first connection configuration of FIG. 1 to the second connection configuration of FIG. 2 and when the user takes out the portable network connection device 20 and some other constituents from the location A to the location C to change from the first connection configuration of FIG. 1 to the third connection configuration of FIG. 3, the DHCP server function module 125 of the main unit 100 is not notified of the DHCP server priority of the router 500. In such cases, the DHCP server function module 125 of the main unit 100 performs step S65 to set the main unit 100 to work as the primary server. At the location A, the DHCP server function module 323 of the router 500 is also not notified of the DHCP server priority of the main unit 100 (i.e., does not receive the DHCP server priority broadcasted by the main unit 100), so that the router 500 accordingly keeps working as the primary server.

A4. Address Range Adjustment Process

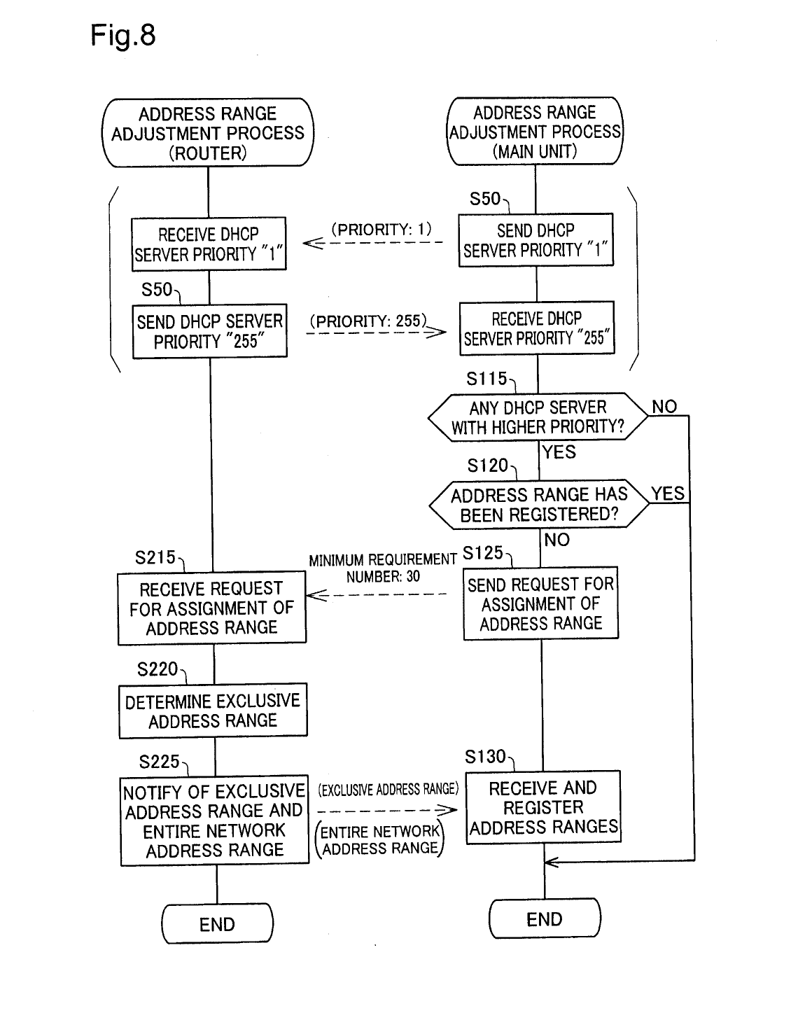

FIG. 8 is a sequence diagram showing the procedure of address range adjustment process performed in the IP address assignment system 10. The left flow shows the processing flow performed by the router 500, and the right flow shows the processing flow performed by the portable network connection device 20 (main unit 100). According to the first embodiment, the IP address range assignable to the client by the main unit 100 is set by the address range adjustment process performed by the main unit 100 and the router 500. The address range adjustment process is triggered by power-ON of the portable network connection device 20 and the router 500.

After the power-ON, the DHCP server arbitration process described above is performed at regular intervals in the router 500 and the main unit 100. In the first connection configuration of the IP address assignment system 10 (FIG. 1), the main unit 100 receives the DHCP server priority “255” from the router 500 at step S50 as described above. The address range adjuster 126 of the main unit 100 determines whether there is any DHCP server with the higher DHCP server priority than the own DHCP server priority (step S115), based on the received DHCP server priority and the own DHCP server priority “1” set in the main unit 100. This determination process is equivalent to the determination of step S55 in the DHCP server arbitration process described above. The address range adjuster 126 may accordingly determine whether there is any DHCP server with the higher DHCP server priority, based on the determination result of step S55.

When it is determines that there is any DHCP server with the higher DHCP server priority than the own DHCP server priority (step S115: Yes), the address range adjuster 126 subsequently determines whether the address range assignable to the client has already been registered (step S120). More specifically, the address range adjuster 126 determines whether the assignable address range has already been registered, based on whether the assignable address range has already been stored in the address management table storage module 17b.

When it is determined that the address range assignable to the client has not yet been registered (step S120: No), the address range adjuster 126 of the main unit 100 sends a request for assignment of address range assignable to the client, to the router 500 (step S125). According to the first embodiment, a minimum requirement number of IP addresses to be assigned is specified in this request for assignment of address range and is, for example, “30” in the exemplary flow of FIG. 8. For example, the minimum requirement number may be set in advance in the main unit 100 by the user (system administrator).

When receiving the request for assignment of address range output from the main unit 100 (step S215), the address range controller 324 of the router 500 determines the IP address range to be assigned to the main unit 100, based on the minimum requirement number specified in the received request for assignment of address range (step S220).

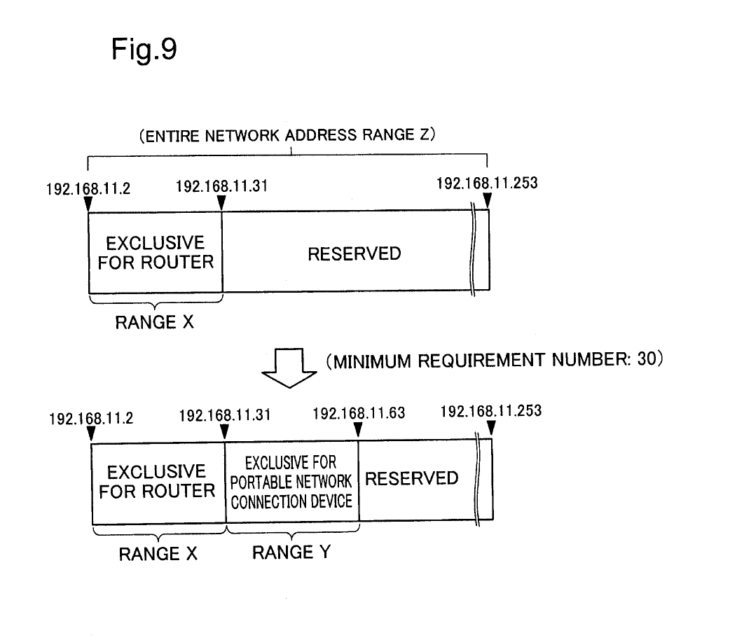

FIG. 9 schematically shows an example of the settings of an address management table stored in the address management table storage module 342 of the router 500 shown in FIG. 5. The upper drawing shows the contents of the address management table before the processing of step S220, and the lower drawing shows the contents of the address management table after the processing of step S220 by the router 500.

An entire network address range Z (192.168.11.2 to 192.168.11.253) shown in the upper drawing of FIG. 9 means the IP address range assignable to the client by the entire system and is set in advance by the user (system administrator). An address range X (192.168.11.2 to 192.168.11.31) shown in the upper drawing of FIG. 9 means the IP address range assignable to the client by the router 500 and is set in advance by the user (system administrator). This address range X can be used only by the router 500 and represents a group of IP addresses assignable to the client only by the router 500. The group of IP addresses assignable to the client only by one device is hereinafter called “exclusive address range”.

When receiving the request for assignment of address range including the specified minimum requirement number, the address range controller 324 of the router 500 determines an address range that at least satisfies the specified minimum requirement number within the remaining range other than the address range X (reserved range) in the entire network address range Z, as an exclusive address range of the main unit 100. As shown in the lower drawing of FIG. 9, for example, when receiving the request for assignment of address range including “30” as the specified minimum requirement number, the address range controller 324 determines an address range Y (192.168.11.32 to 192.168.11.63) as the exclusive address range of the portable network connection device 20 (main unit 100). In this case, the address range Y includes a total of 32 IP addresses.

The remaining range (192.168.11.64 to 192.168.11.253) other than the address range X and the address range Y in the entire network address range Z is set as the reserved range and is not assigned to any device at this moment. The addresses in this reserved rang may be used as backup addresses to be used when the addresses included in the exclusive address range X of the router 500 and the addresses included in the exclusive address range Y of the main unit 100 are all assigned with no newly assignable address remaining. When another portable network connection device different from the portable network connection device 20 newly joins the IP address assignment system 10, this reserved range may be used as the address range to be assigned to the newly joining portable network connection device.

After determining the exclusive address range, the address range controller 324 of the router 500 notifies the portable network connection device 20 (main unit 100) of the assigned exclusive address range and the entire network address range (step S225). According to this embodiment, when the address range Y is determined as the exclusive address range for the main unit 100 as described above, this exclusive address range Y and the entire network address range Z are notified to the main unit 100.

The address range adjuster 126 of the main unit 100 receives the exclusive address range and the entire network address range and registers the received exclusive address range (step S130). More specifically, the address range adjuster 126 generates an address management table and stores the generated address management table into the address management table storage module 342. When the address range Y (192.168.11.32 to 192.168.11.63) is notified by the router 500 as described above, this notified address range is registered in the main unit 100 as the IP address range assignable to the client.

The address range adjustment process accordingly sets the address ranges that are exclusively used by the router 500 and by the main unit 100 and do not overlap each other.

A5. DHCP Server Process

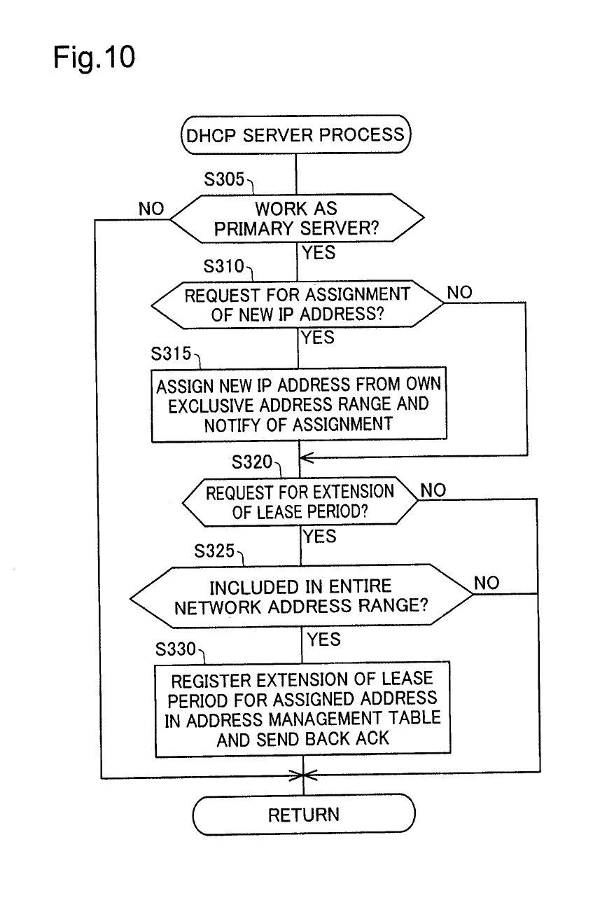

FIG. 10 is a flowchart showing the procedure of DHCP server process performed by the router 500 and the portable network connection device 20 (main unit 100). According to the first embodiment, the DHCP server process is performed at regular intervals in the router 500 and in the portable network connection device 20 (main unit 100). The DHCP server arbitration process (FIG. 7) is also performed at regular intervals. It is accordingly preferable to start the DHCP server process after the last step (step S70) of the DHCP server arbitration process. The following describes an exemplary flow of the DHCP server process performed by the portable network connection device 20 (main unit 100), but the same series of processing is performed by the router 500.

The DHCP server function module 323 of the main unit 100 determines whether the main unit 100 works as the primary server (step S305). When it is determined that the main unit 100 does not work as the primary server (but works as the secondary server) (step S305: No), the DHCP server function module 323 returns to step S305 without any further processing and repeats the processing of step S305. When it is determined that the main unit 100 works as the primary server (step S305: Yes), on the other hand, the DHCP server function module 323 subsequently determines whether there is a request for assignment of new IP address from a client (step S310). Working as the primary server or as the secondary server is determined based on whether the function part is inactivated at step S60 in the DHCP server arbitration process (FIG. 7) described above. For example, a DHCP Discovery message or a DHCP Request message may be employed as the criterion for determining the presence or the absence of a request for assignment of new IP address from a client.

When it is determined that there is a request for assignment of new IP address from a client (step S310: Yes), the DHCP server function module 125 of the main unit 100 newly assigns an IP address in the own exclusive address range to the client and notifies the client of the assigned IP address (step S315).

After step S315 or when it is determined that there is no request for assignment of new IP address from a client (step S310: No), the DHCP server function module 125 of the main unit 100 subsequently determines whether there is a request for extension of the lease period of an IP address from the client, to which the IP address has been assigned (step S320).

For example, a DHCP Request message may be employed as the criterion for determining the presence or the absence of a request for extension of the lease period. When the DHCP Request message is employed, this message is sent to a specified destination (i.e., server to which the IP address has been assigned) by unicast. For example, the second client CL2 of FIG. 2 moved to the location B after assignment of the IP address (192.168.11.3) from the router 500 as the primary server at the location A unicasts the request for extension of the lease period to the router 500 as the destination. At the location B, however, the router 500 is not present, but the main unit 100 works as the primary server. According to the first embodiment, the DHCP server function module 125 of the main unit 100 learns in advance the IP address and the MAC (Media Access Control) address of the router 500, while the DHCP server function module 323 of the router 500 learns in advance the IP address and the MAC address of the main unit 100. Each of the main unit 100 and the router 500 is configured to receive the request for extension of the lease period addressed to the learnt address of the other device. For example, at the location B shown in FIG. 2, the request for extension of the lease period output from the second client CL2 to be addressed to the router 500 is received by the main unit 100.

When it is determined that there is a request for extension of the lease period (step S320: Yes), the DHCP server function module 125 of the main unit 100 subsequently determines whether the IP address as the subject of the request for extension is included in the entire network address range (step S325). When the IP address as the subject of the request for extension is included in the entire network address range (step S325: Yes), the DHCP server function module 125 of the main unit 100 registers the extension of the lease period for the IP address as the subject of the request for extension in the address management table and sends back a packet representing the permission for extension (ACK packet) to the client (step S330). It should be noted here that the ACK packet is transmitted at step S330, despite the fact that the IP address as the subject of the request for extension is not included in the exclusive address range of the main unit 100. The ACK packet is not sent in response to a request for extension with respect to the IP address that is not included in the entire network address range, since the DHCP server function module 125 cannot determine the permission or refusal.

When it is determined that there is no request for extension of the lease period (step S320: No), when it is determined that the IP address as the subject of the request for extension is not included in the entire network address range (step S325: No), or after the processing of step S330, the EHCP server process is terminated.

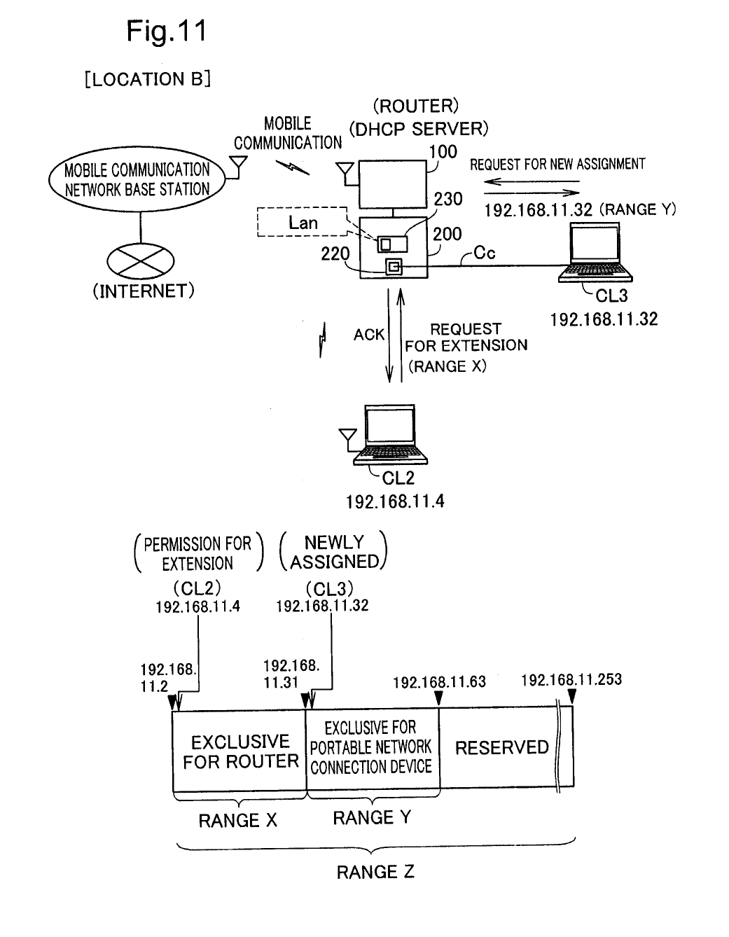

FIG. 11 is a first view illustrating an example of the DHCP server process. The upper drawing of FIG. 11 shows an example in the state where the main unit 100 performs the DHCP server process (FIG. 10) at the location B shown in FIG. 2. The lower drawing of FIG. 11 shows the address ranges X, Y and Z and the IP addresses respectively assigned to the second client CL2 and the third client CL3 in the example of the upper drawing of FIG. 11.

As described above, at the location B, the portable network connection device 20 (main unit 100) works as the primary server. When a request for extension of the lease period with respect to the previously assigned IP address (192.168.11.4) is output from the second client CL2, the step S330 is performed to give permission to the request for extension of the assigned IP address, since this IP address (192.168.11.4) is not included in the exclusive address range Y of the main unit 100 but is included in the entire network address range Z.

The processing of step S315 is performed, in response to a request for assignment of new IP address from the third client CL3 newly joining the IP address assignment system 10 at the location B. For example, the IP address (192.168.11.32) included in the exclusive address range Y of the main unit 100 is then assigned to the third client CL3 as shown in FIG. 11.

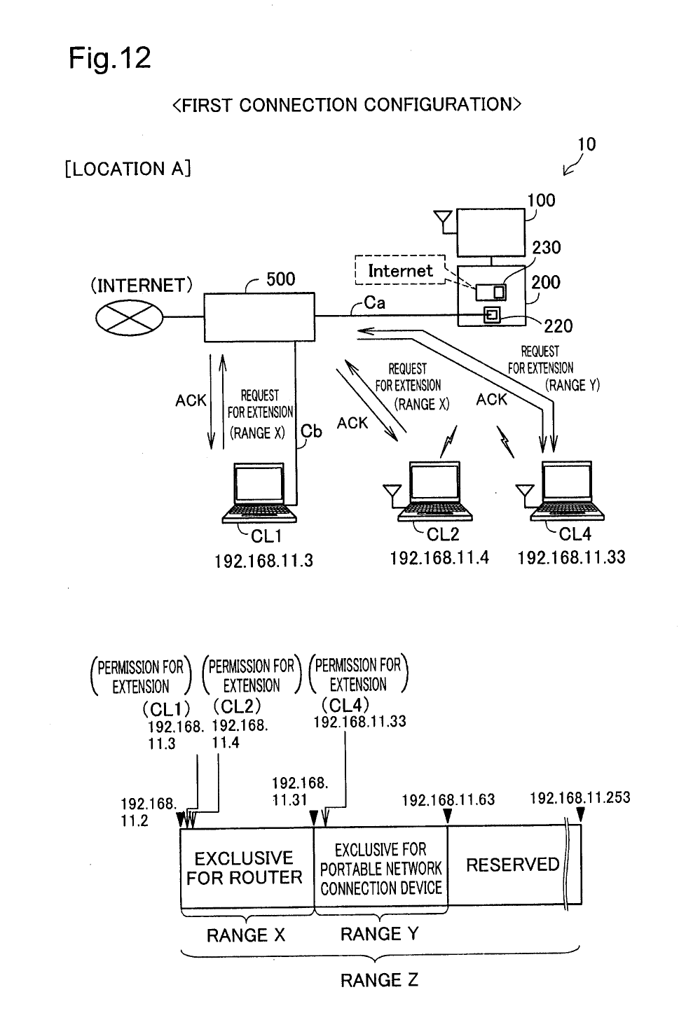

FIG. 12 is a second view illustrating another example of the DHCP server process. The upper drawing of FIG. 12 shows an example where the router 500 and the main unit 100 perform the DHCP server process (FIG. 10) in the state that the main unit 100, the second client CL2 and the fourth client CL4 placed at the location C shown in the lower drawing of FIG. 3 are bought back to the location A to achieve the first connection configuration. The lower drawing of FIG. 12 shows the address ranges X, Y and Z and the IP addresses respectively assigned to the first client CL1, the second client CL2 and the fourth client CL4 in the example of the upper drawing of FIG. 12.

When the main unit 100 is brought back from the location C to the location A, the router 500 having the higher DHCP server priority is present at the location A. The main unit 100 working as the primary server is accordingly set to work as the secondary server as the result of the DHCP server arbitration process (step S60 shown in FIG. 7). The requests for extension of the lease period output from the three clients CL1, CL2 and CL4 are all received by the router 500 serving as the primary server. The IP address (192.168.11.33) assigned to the fourth client CL4 is not included in the exclusive address range X of the router 500. The IP address assigned to the fourth client CL4 is, however, included in the entire network address range Z (step S325: Yes in FIG. 10), the router 500 gives permission to the request for extension of the IP address (step S330 in FIG. 10).

In the IP address assignment system 10 of the first embodiment described above, the exclusive address range of the main unit 100 (address range Y) and the exclusive address range of the router 500 (address range X) are set in a non-overlapping manner in the entire network address range Z (FIGS. 9, 11 and 12). This prevents the main unit 100 and the router 500 from assigning one identical IP address to different clients. When the portable network connection device 20 (main unit 100) and the router 500 located remote from each other respectively work as the DHCP server (primary server) to assign IP addresses to clients, such setting ensures no overlap of the IP addresses assigned to these clients. When the portable network connection device 20 (main unit 100) and the client are returned to the network (broadcast domain), which the router 500 belongs to, such setting effectively prevents the occurrence of communication failure due to the overlapped IP address. Additionally, the exclusive address ranges of the main unit 100 and the router 500 are set in a non-overlapping manner, so that there is no need to send and receive data for synchronizing the respective address pools between the main unit 100 and the router 500 after completion of the address range adjustment process (FIG. 8). Even when the main unit 100 and the router 500 cannot communicate with each other, for example, due to network failure, such setting effectively prevents overlapped assignment of the same IP address.

The main unit 100 and the router 500 both working as the primary servers are configured to receive a request for extension of the lease period of an IP address, which is assigned to a client by the other device, from the client and respond to the received request (steps S320 to S330 in FIG. 10). When the main unit 100 and the router 500 belong to the same network and one of the main unit 100 and the router 500 is set to work as the secondary server with the inactive function part out of the DHCP server functions, such configuration effectively prevents the client from receiving no response to its request for extension.

The main unit 100 and the router 500 both perform the DHCP server arbitration process to exchange the own DHCP server priorities, so that the device having the higher DHCP server priority works as the primary server (FIG. 7). The user (system administrator) can specify the device to be preferentially operated as the primary server by simply adjusting the DHCP server priority. As the result of the DHCP server arbitration process, only one of the main unit 100 and the router 500 is set to provide the function on IP address assignment (steps S60 and S65 in FIG. 7). This effectively prevents both the main unit 100 and the router 500 from separately assigning IP addresses (different IP addresses) to one identical client. This does not require the client to perform the process of selecting one IP address out of the plurality of separately assigned IP addresses and thereby reduces the processing load of the client. Additionally, this also saves the unnecessary IP address assignment by either the main unit 100 or the router 500, which is not selected by the client.

The router 500 determines and totally manages the exclusive address ranges to be assigned to the main unit 100 and the router 500 (step S220 in FIG. 8). Compared with the method of separately managing the exclusive address ranges by a plurality of devices, this method more effectively prevents the potential overlap of the respective exclusive address ranges and does not require the additional mechanism of synchronizing information on their exclusive address ranges between the plurality of devices.

The address range adjustment process specifies the minimum requirement number of IP addresses to be assigned, in the request for assignment of address range sent from the main unit 100 to the router 500 (step S125 in FIG. 8). Such specification enables assignment of the minimal address range by the router 500 and reduces the ineffective address range that cannot be actually assigned to the client in the entire network address range Z. The procedure of the first embodiment described above specifies the address range including 32 assignable IP addresses as the exclusive address range Y relative to the minimum requirement number “30” (FIGS. 9, 11 and 12). Specifying the address range including a slightly larger number of IP addresses than the minimum requirement number can deal with estimation error by the side requiring the address assignment or a little increase in number of clients.

The address range adjustment process notifies the main unit 100 of the entire network address range in addition to the assigned exclusive address range (step S225 in FIG. 8). The main unit 100 can thus determine whether the IP address as the subject of the request for extension of the lease period sent from the client is the valid IP address assigned in the IP address assignment system 10 (step S325 in FIG. 10).

The main unit 100 and the router 500 perform the DHCP server arbitration process at regular intervals (step S70 in FIG. 7). When the main unit 100 newly joins the network NW2 or NW3 different from the network NW1, which the router 500 belongs to, the main unit 100 can thus promptly detect the absence of the router 500 in the network NW2 or NW3, which the main unit 100 currently belongs to. This advantageously shortens the period of time without any primary server in the network NW2 or NW3, thus reducing the time period with no IP address assignment or no determination of the permission or refusal for extension of the lease period.

### B. Second Embodiment

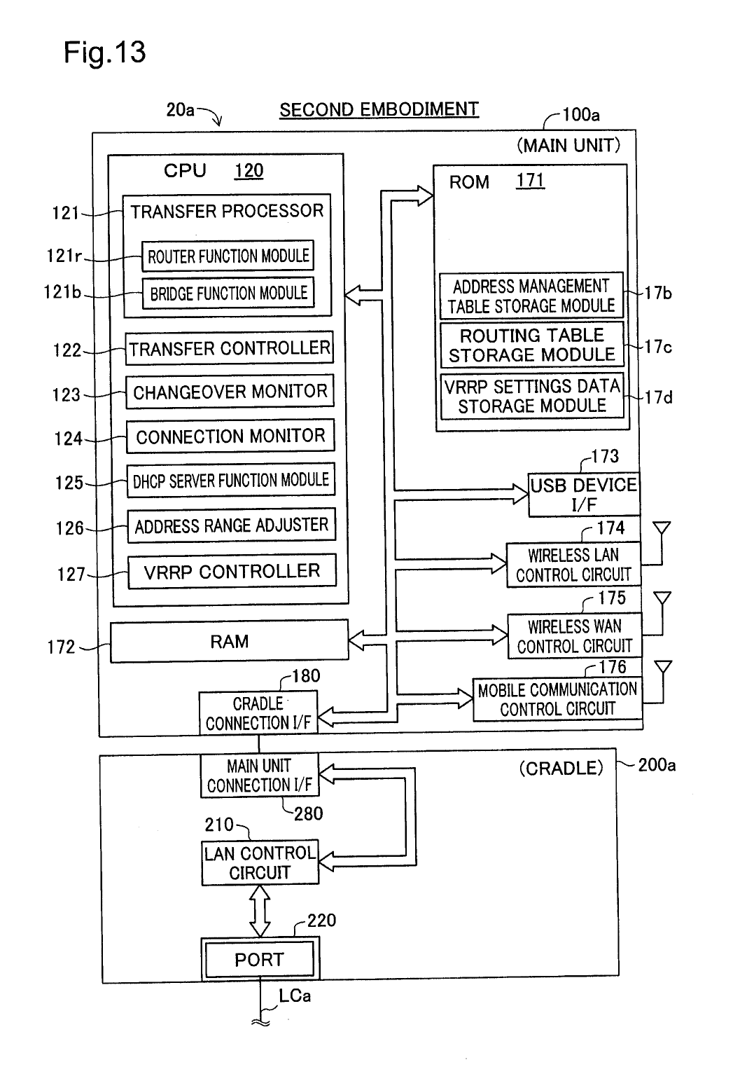

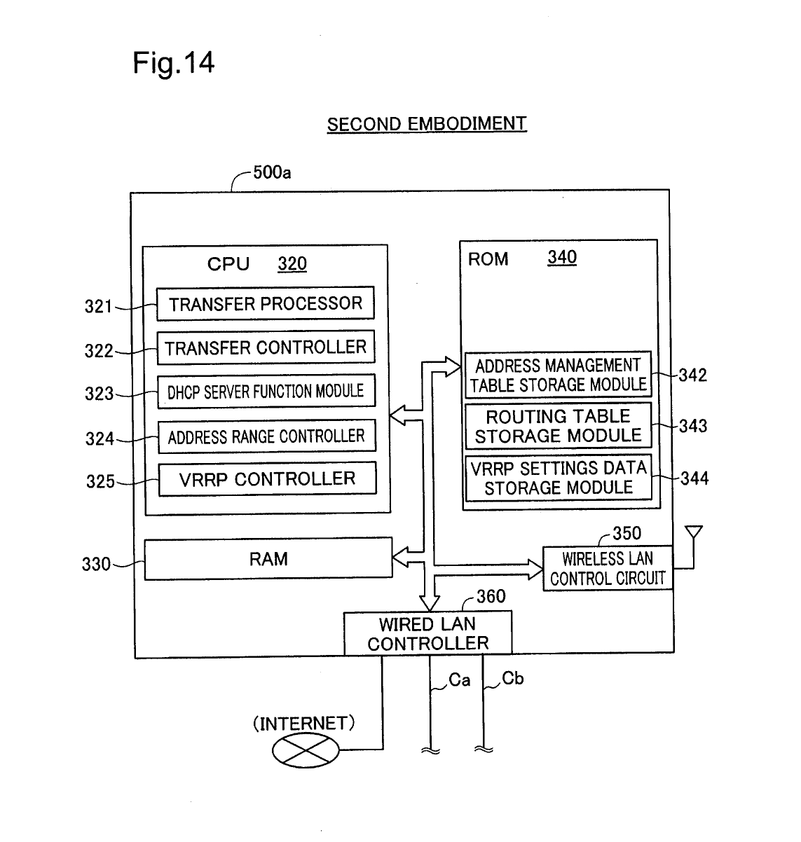

FIG. 13 illustrates the detailed structure of a portable network connection device 20a according to a second embodiment. FIG. 14 illustrates the detailed structure of a router 500a according to the second embodiment. In the IP address assignment system of the second embodiment, the portable network connection device 20a and the router 500a form one virtual router by VRRP (Virtual Router Redundancy Protocol). The IP address assignment system of the second embodiment accordingly differs from the IP address assignment system 10 of the first embodiment by the detailed structures of the portable network connection device and the router. The IP address assignment system of the second embodiment also differs from the IP address assignment system 10 of the first embodiment by omission of the operation mode changeover process and the procedures of the DHCP server arbitration process and the address range adjustment process. Otherwise the IP address assignment system of the second embodiment has the similar configuration to that of the IP address assignment system 10 of the first embodiment.

The portable network connection device 20a of the second embodiment shown in FIG. 13 differs from the portable network connection device 20 of the first embodiment shown in FIG. 4 by the following points. In the portable network connection device 20a of the second embodiment, a main unit 100a does not have the DHCP server priority storage module 17a but includes a VRRP settings data storage module 17d and a VRRP controller 127. In the portable network connection device 20a of the second embodiment, a cradle 200a does not have the changeover switch 230. Otherwise the portable network connection device 20a of the second embodiment has the similar structure to that of the portable network connection device 20 of the first embodiment.

The VRRP settings data storage module 17d stores various setting values required for implementing the VRRP protocol. More specifically, the VRRP settings data storage module 17d stores, for example, a VRID (Virtual Router ID), the priority, an advertising interval (i.e., time interval for outputting VRRP advertisement), and an IP address and a MAC address assigned to the virtual router. These setting values are set in advance by the user (system administrator).

The VRRP controller 127 implements series of processing conforming to the VRRP protocol. For example, the VRRP controller 127 sends a VRRP advertisement message and receives a VRRP advertisement message from another router. The VRRP controller 127 also determines whether the main unit 100a works as a master router or a backup router, based on the received VRRP advertisement message.

The router 500a of the second embodiment shown in FIG. 14 differs from the router 500 of the first embodiment shown in FIG. 5 by the following points. The router 500a of the second embodiment does not have the DHCP server priority storage module 341 but includes a VRRP settings data storage module 344 and a VRRP controller 325. Otherwise the router 500a of the second embodiment has the similar structure to that of the router 500 of the first embodiment.

Like the VRRP settings data storage module 17d shown in FIG. 13, the VRRP settings data storage module 344 stores the setting values required for implementing the VRRP protocol. The setting values are set in advance by the user (system administrator). The VRRP controller 325 works similarly to the VRRP controller 127 shown in FIG. 13.

The same value is set as the VRID in the main unit 100a and the router 500a. The same values are also set as the IP address and the MAC address of the virtual router in the main unit 100a and the router 500a. The higher VRRP priority is set in the router 500a than the VRRP priority set in the main unit 100a.

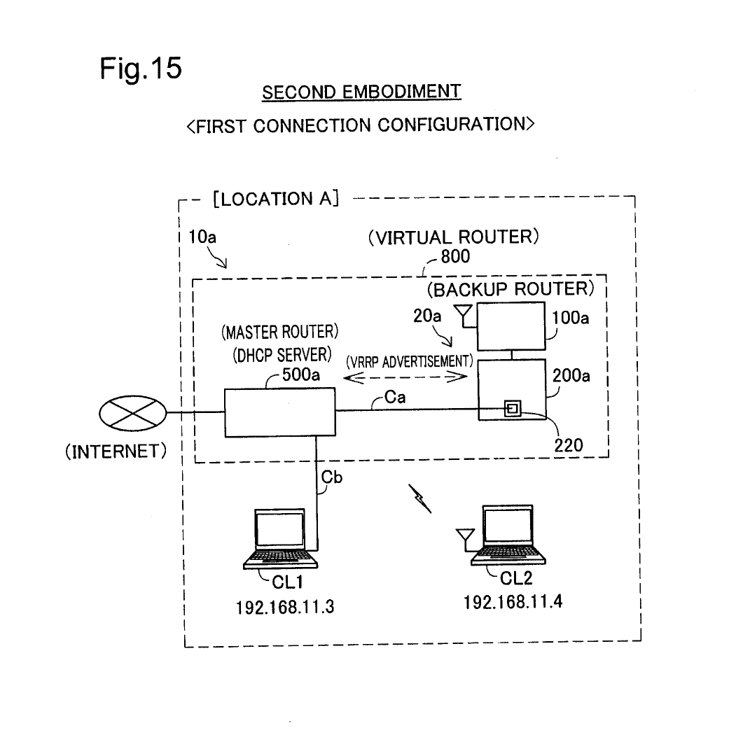

FIG. 15 illustrates a first connection configuration of the second embodiment. The first connection configuration of the second embodiment shown in FIG. 15 differs from the first connection configuration of the first embodiment shown in FIG. 1 by the following points. In the first connection configuration of the second embodiment, a virtual router 800 is formed by the router 500a and the portable network connection device 20a (main unit 100a). The second client CL2 establishes wireless communication with the router 500a, in place of the main unit 100a and enables communication via the Internet by the router 500a. Otherwise the first connection configuration of the second embodiment is similar to the first connection configuration of the first embodiment.

As shown in FIG. 15, the router 500a and the portable network connection device 20a (main unit 100a) send and receive VRRP advertisement messages each other and are thereby notified of the priority of the other. In the first connection configuration, the router 500a with the higher priority serves as a router that actually relays packets (master router), while the main unit 100a with the lower priority servers as a router that does not actually relay packets (backup router). When intending to send data to a destination on the Internet, the second client CL2 accordingly sends the data (packet) to the router 500a, unlike the first embodiment (FIG. 1).

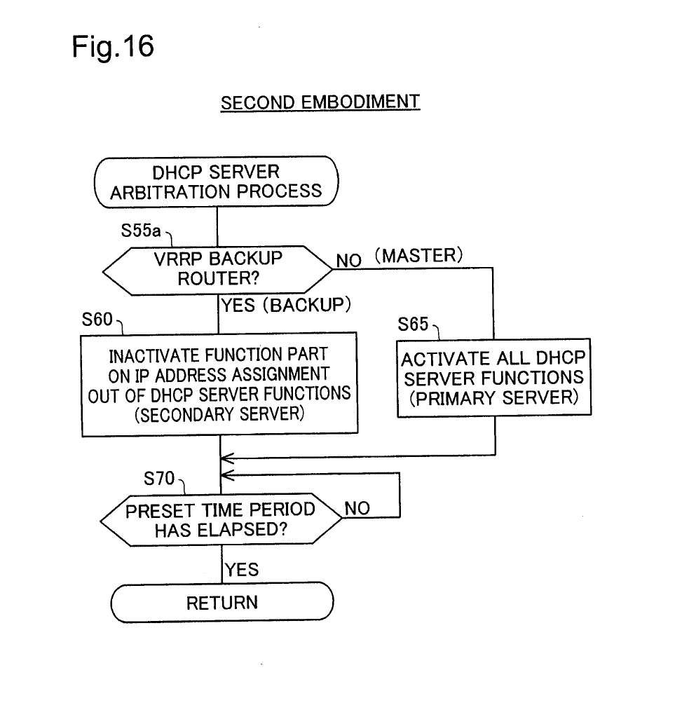

FIG. 16 is a flowchart showing the procedure of DHCP server arbitration process according to the second embodiment. The DHCP server arbitration process of the second embodiment differs from the DHCP server arbitration process of the first embodiment shown in FIG. 7 by omission of step S50 and replacement of step S55 with step S55a. Otherwise the procedure of the DHCP server arbitration process of the second embodiment is similar to the procedure of the DHCP server arbitration process of the first embodiment. The following describes the DHCP server arbitration process performed by the main unit 100a, while the router 500a similarly performs the DHCP server arbitration process.

As shown in FIG. 16, the DHCP server function module 125 of the main unit 100a determines whether the portable network connection device 20a (main unit 100a) works as the VRRP master router (step S55a). The determination is based on inquiry to the VRRP controller 127.

When it is determined that the main unit 100a works as the backup router (step S55a: Yes), the processing of step S60 described above (FIG. 7) is performed. When it is determined that the main unit 100a does not work as the backup router (i.e., works as the master router) (step S55a: No), on the other hand, the processing of step S65 described above (FIG. 7) is performed.

In the IP address assignment system of the second embodiment, the device working as the master router serves as the primary server on the DHCP server functions, whilst the device working as the backup router serves as the secondary server on the DHCP server functions. In the first connection configuration, the router 500a works as the master router and thereby serves as the primary server on the DHCP server functions. The main unit 100a works as the backup router and thereby serves as the secondary server on the DHCP server functions. Like the first embodiment, in the first connection configuration, the router 500a performs assignment of a new IP address to a client, determination of the permission or refusal to a request for extension of the lease period and notification of the determination result.

When the main unit 100a is taken out to the location B as shown in FIG. 2 or when the main unit 100a is taken out to the location C as shown in FIG. 3, the VRRP advertisement messages sent from the main unit 100a and the router 500a do not reach the other, so that the main unit 100a and the router 500a both work as the master routers. Like the first embodiment, both the main unit 100a and the router 500a accordingly work as the primary servers on the DHCP server functions.

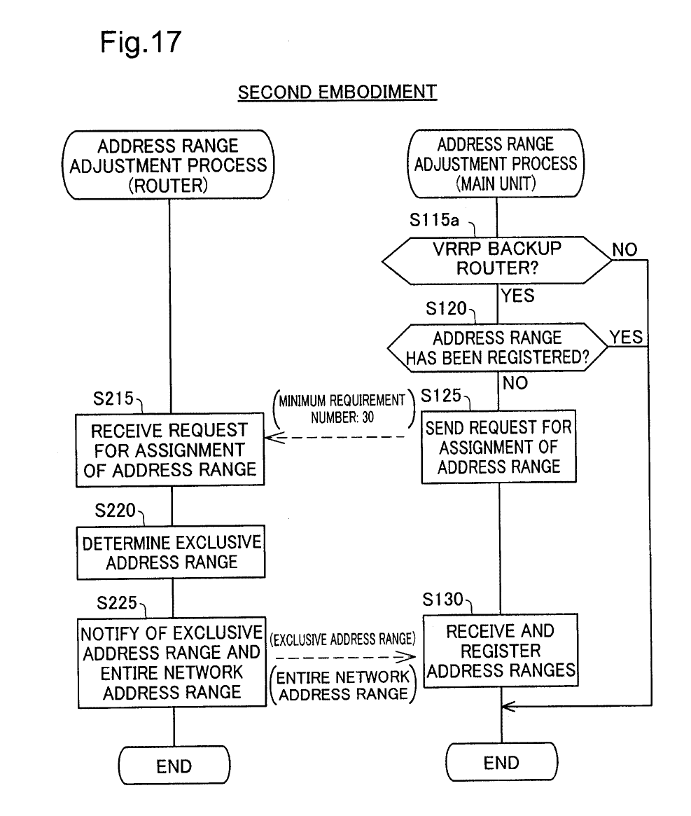

FIG. 17 is a sequence diagram showing the procedure of address range adjustment process according to the second embodiment. The left flow shows the processing flow performed by the router 500a, and the right flow shows the processing flow performed by the portable network connection device 20a (main unit 100a). The address range adjustment process of the second embodiment differs from the address range adjustment process of the first embodiment shown in FIG. 8 by replacement of step S115 with step S115a. Otherwise the procedure of the address range adjustment process of the second embodiment is similar to the procedure of the address range adjustment process of the first embodiment.

In the second embodiment, the main unit 100a determines whether the main unit 100a itself works as the VRRP backup router (step S115a). When it is determined that the main unit 100a itself works as the VRRP backup router (step S115a: Yes), the processing of step S120 described above is performed. When it is determined that the main unit 100a itself does not work as the backup router (i.e., works as the VRRP master router) (step S115a: No), on the other hand, the address range adjustment process is terminated.

In the IP address assignment system of the second embodiment of the above configuration, for example, in the second connection configuration shown in FIG. 11, when the second client CL2 sends a request for extension, the destination of the request for extension is specified by the IP address and the MAC address set in the main unit 100a, because of the following reason. The same IP address and the same MAC address are assigned to the main unit 100a and the router 500a. Irrespective of whether the main unit 100a or the router 500a assigns the IP address to the client, the main unit 100a and the router 500a have the same IP address and MAC address as the DHCP server. The IP address and the MAC address representing the destination of the client's unicasting the request for extension of the lease period of the IP address are equal to the IP address and the MAC address set in the main unit 100a. The IP address assignment system of the second embodiment of this configuration accordingly does not require the process of the first embodiment that the main unit 100a and the router 500a respectively learn the IP address and the MAC address of the other and receive a packet as a request for extension of the lease period addressed to the other. This enables omission of the function for implementing this process and thereby reduces the manufacturing cost of the main unit 100a and the router 500a.

The IP address assignment system of the second embodiment described above has the similar advantageous effects to those of the IP address assignment system 10 of the first embodiment. Additionally, the router 500a and the portable network connection device 20a (main unit 100a) work as the virtual router and use the same IP address and the MAC address. The router 500a or the main unit 100a can thus receive a packet as a request for extension of the lease period from the client, which the IP address has been assigned to by the other device (main unit 100a or router 500a), as the packet addressed to the router 500a or the main unit 100a itself. The main unit 100a and the router 500a accordingly do not require the function of receiving a packet as a request for extension of the lease period addressed to the other device with the IP address and the MAC address of the other device as the destination, thereby having the reduced manufacturing cost.

In the second embodiment, either the router 500a or the portable network connection device 20a (main unit 100a) working as the VRRP master router serves as the primary server, while the device working as the backup router serves as the secondary server. The second embodiment may thus omit the process of setting and receiving and sending the DHCP server priorities for determining the primary server and the secondary server, as well as the DHCP server arbitration process (FIG. 7).

### C. Third Embodiment

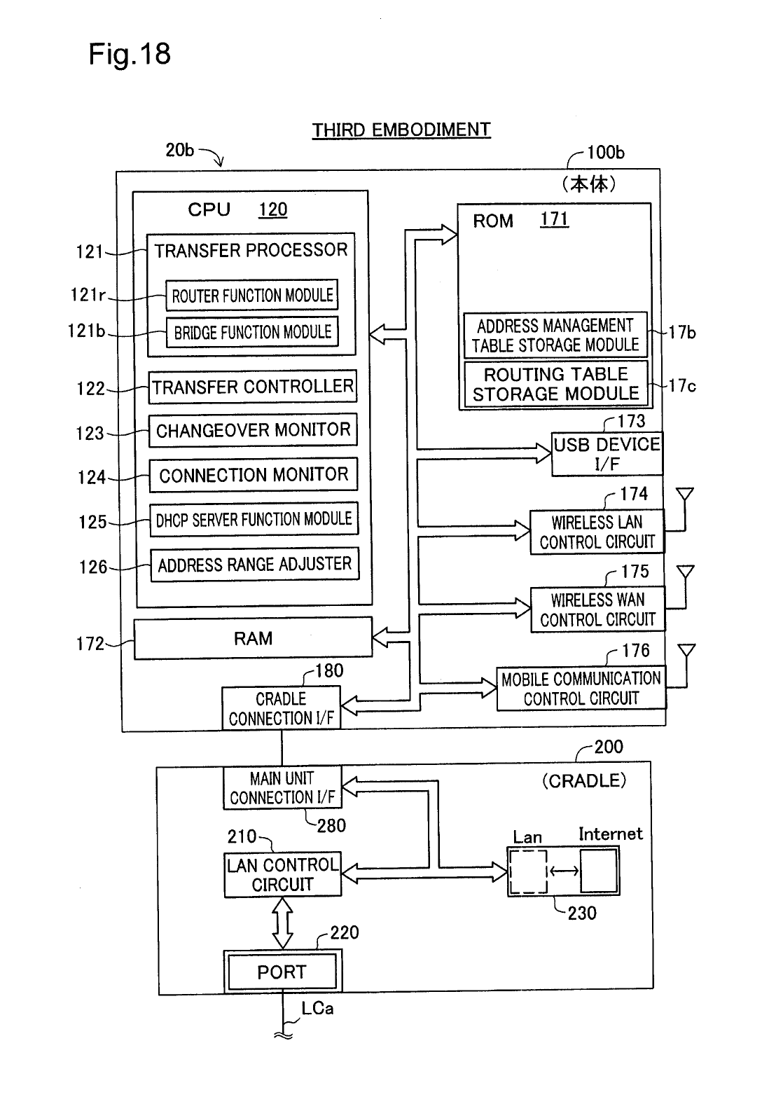

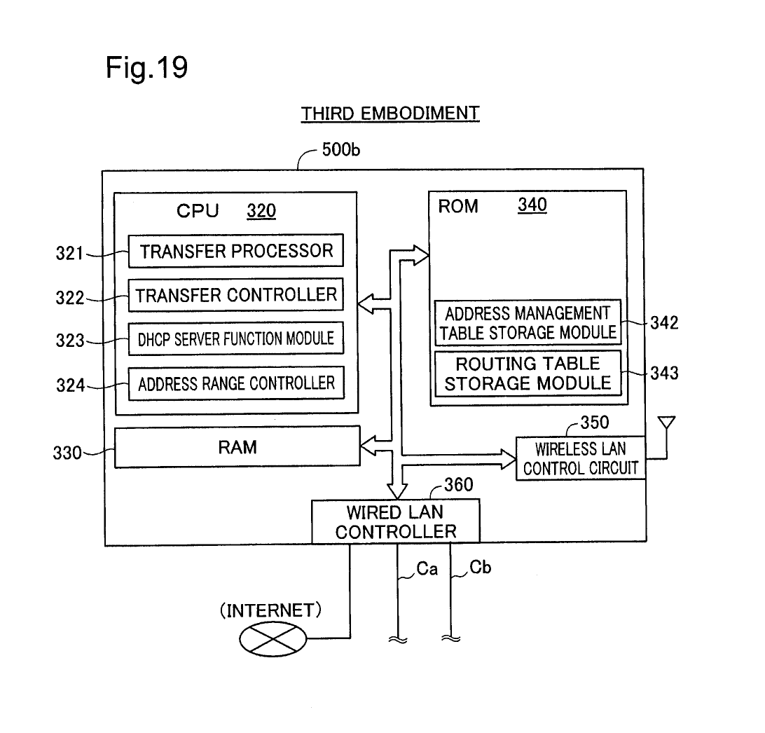

FIG. 18 illustrates the detailed structure of a portable network connection device according to a third embodiment. FIG. 19 illustrates the detailed structure of a router 500b according to the third embodiment. In the IP address assignment system of the third embodiment, the DHCP server priorities are not set in a main unit 100b and the router 500b. More specifically, the main unit 100b shown in FIG. 18 does not have the DHCP server priority storage module 17a. Otherwise the main unit 100b has the similar structure to that of the main unit 100 of the first embodiment shown in FIG. 4. The router 500b shown in FIG. 19 does not have the DHCP server priority storage module 341. Otherwise the router 500b has the similar structure to that of the router 500 of the first embodiment shown in FIG. 5. In the IP address assignment system of the third embodiment, the main unit 100a and the router 500b do not perform the processing of step S50 (broadcasting the DHCP server priority) shown in FIG. 7. In the IP address assignment system of the third embodiment, the router 500b always works as the primary server.

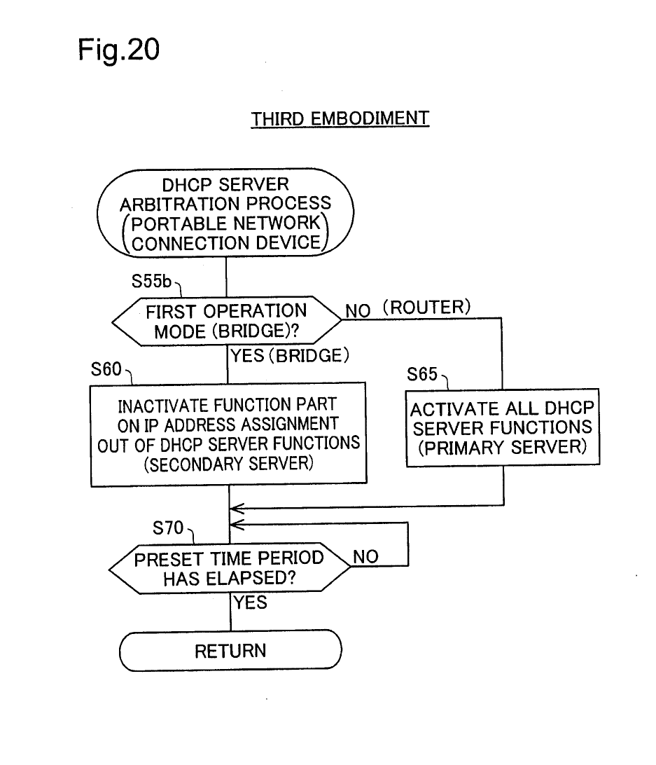

FIG. 20 is a flowchart showing the procedure of DHCP server arbitration process according to the third embodiment. The DHCP server arbitration process shown in FIG. 20 is performed only by the main unit 100b (portable network connection device) and is not performed by the router 50b. The DHCP server arbitration process of the third embodiment differs from the DHCP server arbitration process of the first embodiment shown in FIG. 7 by omission of step S50 and replacement of step S55 with step S55b. Otherwise the procedure of the DHCP server arbitration process of the third embodiment is similar to the procedure of the DHCP server arbitration process of the first embodiment.

As shown in FIG. 20, the DHCP server function module 125 of the main unit 100b determines whether the first operation mode is set as the operation mode of the transfer processor 121 (portable network connection device) (step S55b). This determination may be based on inquiry to the transfer controller 122.

When it is determined that the first operation mode is set (step S55b: Yes), the processing of step S60 described above (FIG. 7) is performed. When it is determined that the first operation mode is not set (i.e., the second operation mode is set) (step S55b: No), on the other hand, the processing of step S65 described above (FIG. 7) is performed.

In the IP address assignment system of the third embodiment, when it is supposed that the router 500b is connected with the main unit 100b, the main unit 100b (portable network connection device) is set to work as the secondary server. When it is supposed that the router 500b is not connected with the main unit 100b, on the other hand, the main unit 100b (portable network connection device) is set to work as the primary server.

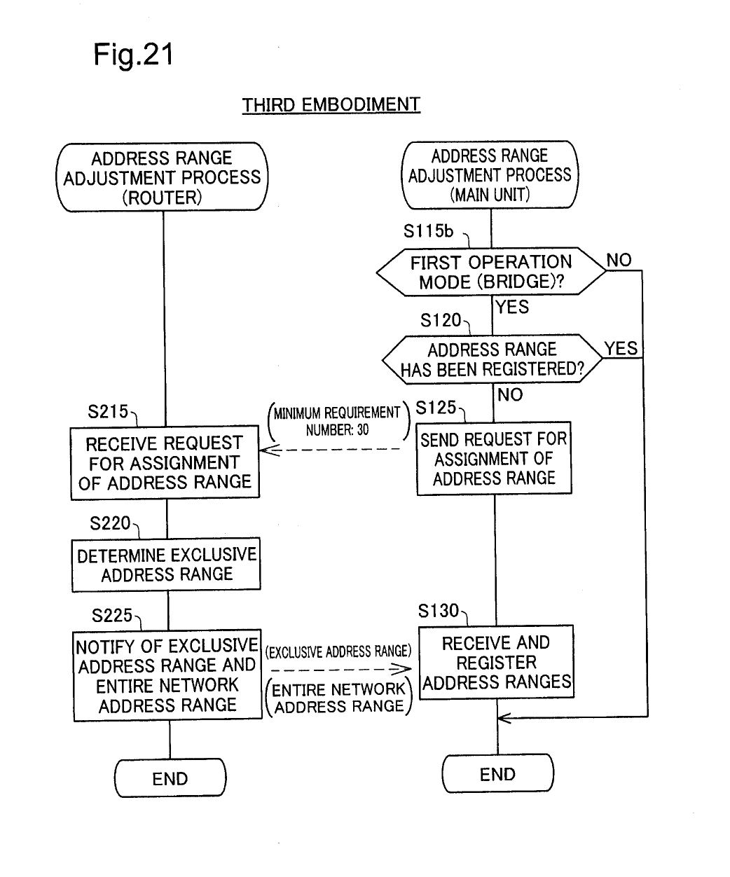

FIG. 21 is a sequence diagram showing the procedure of address range adjustment process according to the third embodiment. The left flow shows the processing flow performed by the router 500b, and the right flow shows the processing flow performed by the portable network connection device (main unit 100b). The address range adjustment process of the third embodiment differs from the address range adjustment process of the first embodiment shown in FIG. 8 by replacement of step S115 with step S115b. Otherwise the procedure of the address range adjustment process of the third embodiment is similar to the procedure of the address range adjustment process of the first embodiment.

In the third embodiment, the main unit 100b determines whether the first operation mode (working as the bridge) is set as the operation mode of the transfer processor 121 (step S115b). When it is determined that the first operation mode is set (step S115b: Yes), the processing of step S120 described above is performed. When it is determined that the first operation mode is not set (i.e., the second operation mode is set) (step S115b: No), on the other hand, the address range adjustment process is terminated.

The IP address assignment system of the third embodiment of the above configuration has the similar advantageous effects to those of the first embodiment. Additionally, the IP address assignment system of the third embodiment does not perform the process of setting and receiving and sending the DHCP server priorities and thereby reduces the processing load of the CPU 120 of the main unit 100b and the CPU 320 of the router 500b.

### D. Modifications

The disclosure is not limited to the above embodiments or their applications, but a multiplicity of variations and modifications may be made to the embodiments without departing from the scope of the disclosure. Some examples of possible modification are given below.

D1. Modification 1

In the above embodiment, the portable network connection device 20 or 20a is the device that is readily taken out from the location where the router 500 or 500a is placed (location A). The disclosure is, however, not limited to this configuration. For example, the portable network connection device 20 or 20a may be replaced by a stationary network device, like the router 500 or 500a. In this application, the first connection configuration is achievable, although the second and the third connection configurations are unachievable. In the first connection configuration, when some failure or abnormality arises in the router 500 or 500a, the stationary network device serves as the primary server. This prevents overlapped assignment of IP addresses and improves the redundancy of the DHCP server.

D2. Modification 2

In the first and the second embodiments described above, the DHCP server arbitration process is performed to limit only one primary server (i.e., server implementing all the DHCP server functions) that is present in the same network. The disclosure is, however, not limited to this configuration. For example, in the first embodiment, both the main unit 100 and the router 500 work as the DHCP servers implementing all the DHCP server functions. In this application, in response to a request for assignment of new IP address (DHCP Discovery) from the same client, the main unit 100 and the router 500 separately send a packet of assigning an IP address (DHCP Offer) to the client. In this application, there is no overlap of the exclusive address ranges set for the main unit 100 and for the router 500, so that the main unit 100 and the router 500 assign different IP addresses to clients. The client is accordingly notified of the two different IP addresses. In this application, the client may be configured to perform the following series of processing. The client may select one of the two IP addresses and send an address setting request (DHCP Request) with explicitly specifying the selected IP address. The method of selecting the IP address employed by the client may select the IP address of the smaller value.

In the above embodiment, the secondary server is configured to perform neither assignment of new IP addresses nor determination of the permission or refusal of extension of the lease period and notification of the determination result. Alternatively the secondary server may be configured to perform determination of the permission or refusal of extension of the lease period and notification of the determination result with no performing assignment of new IP addresses. In this application, for example, when the main unit 100 or the portable network connection device 20 is brought back from a different location to the location A as shown in FIG. 12, the router 500 is not required to receive a request for extension output from the client, which an IP address has been assigned to by the main unit 100 (fourth client CL4) and perform determination of the permission or refusal of extension and notification of the determination result

D3. Modification 3

The router 500 or 500a also works as the DHCP server according to the above embodiments, but the disclosure is not limited to such embodiments. For example, another DHCP server may be provided separately from the router 500 or 500a at the location A, and the router 500 or 500a may be configured to primarily relay layer 3 packets. In this application, in place of the router 500 or 500a, the DHCP server performs the DHCP server arbitration process, the address range adjustment process and the DHCP server process.

D4. Modification 4

The procedure of the first embodiment uses the DHCPINFORM message to send the DHCP server priority, but another packet (for example, an exclusive packet for sending the DHCP server priority) may be used for the same purpose. The packet for sending the DHCP server priority is sent by broadcast according to the first embodiment, but may alternatively be sent by unicast. In this latter application, it is preferable to set in advance an IP address and a MAC address of the opposite side.

D5. Modification 5

In the above embodiment, the second connection configuration may be achieved when the portable network connection device 20 and some other constituents are taken out from the first connection configuration. Alternatively, the second connection configuration may be achieved by providing the router 500 and some other constituents at the location A and providing the portable network connection device 20 and some other constituents at the location B. Similarly, in the above embodiment, the third connection configuration may be achieved when the main unit 100 and some other constituents are taken out from the first connection configuration. Alternatively, the third connection configuration may be achieved by providing the router 500 and some other constituents at the location A and providing the main unit 100 and some other constituents at the location C.

In these alternative applications, for example, the entire network address range Z as the address range of IP addresses assignable to the client by the whole system and the exclusive address range X as the address range of IP addresses assignable to the client by the router 500 may be set in advance by the user (system administrator). The entire network address range Z and the exclusive address range X may be stored in the address management table storage module 342 of the router 500 by the user. The entire network address range Z and the exclusive address range Y of the portable network connection device 20 may be set in advance by the user (system administrator). The entire network address range Z and the exclusive address range Y may be stored in the address management table storage module 17b of the main unit 100 by the user.

D6. Modification 6

The minimum requirement number specified in the request for assignment of address range is “30” in the above embodiment but may be any other arbitrary number. The minimum requirement number is set in the main unit 100 or 100a according to the above embodiments, but the disclosure is not limited to these embodiments. According to another embodiment, IP address assignment history may be stored in the writable ROM 171 of the main unit 100 or 100a, and the total number of IP addresses newly assigned to clients after the previous assignment of the address range may be counted, based on this history. The minimum requirement number may be determined, based on the counted total number. For example, when the total number of IP addresses newly assigned to clients after the previous assignment of the address range is “40”, it is highly probable that at least 40 IP addresses are assigned to clients this time. An arbitrary number of or over 40 (for example, 45) may thus be set as the minimum requirement number. In this application, the minimum requirement number is set based on the history, so that the necessary and sufficient number can be set as the minimum requirement number. This prevents an excessively wide exclusive address range from being set for the main body 100 or 100a and thereby reduces the ineffective IP addresses that cannot be assigned to the client. In this application, the ROM 171 corresponds to the history storage unit described above. The minimum requirement number corresponds to the minimum requirement range described above.

Instead of being set in the main unit 100 or 100a, the number of IP addresses to be assigned to the main unit 100 or 100a may be set in advance in the router 500 or 500a.

In response to a request for assignment of address range from the main unit 100 or 100a, the whole range other than the exclusive address range set for the router 500 or 500a (address range X) in the entire network address range Z may be set as the exclusive address range of the main unit 100 or 100a. In this application, the main unit 100 or 100a is not required to notify the router 500 or 500a of the minimum requirement number.

In the above embodiment, the range including a little greater number of IP addresses than the minimum requirement number is determined as the exclusive address range. Alternatively the range including just the same number of IP addresses as the minimum requirement number may be determined as the exclusive address range.

D7. Modification 7

In the above embodiment, the primary server assigns an IP address to each client. Alternatively the primary server may notify each client of the IP address of the default gateway or the IP address of a DNS (Domain Name Service) server, in addition to assignment of the IP address.

D8. Modification 8

In the above embodiment, in response to a request for extension of the lease period, the DHCP server process determines whether the IP address as the subject of the request for extension is included in the entire network address range (step S325). This processing of step S325 may be omitted. Unless any device performing IP address assignment other than the router 500 or 500a and the main unit 100 or 100a is added to the system, the IP address assigned to each client should be always included in the entire network address range. In this case, the processing of step S325 may be omitted. Omission of such processing advantageously reduces the processing load of the router 500 or 500a and the main body 100 or 100a.

D9. Modification 9

The structure of the portable network connection device 20 or 20a described in each of the above embodiments is only illustrative and may be changed, altered and modified in various ways. For example, the cradle connection interface 180 of the main unit 100 or 100a and the main unit connection interface 280 of the cradle 200 or 200a transmit information in conformity with the USB standards according to the above embodiments. Alternatively, information may be transmitted between the main unit 100 or 100a and the cradle 200 or 200a in conformity with any standards other than the USB standards.

According to another embodiment, the wireless LAN control circuit 174 and the wireless WAN control circuit 175 may be constructed as wireless communication interfaces configured to make wireless communication by the wireless LAN conforming to the IEEE802.11a/b/g standard, as well as any future available wireless LAN. The mobile communication control circuit 176 may be constructed as a wireless communication interface configured to make wireless communication by mobile communication conforming to the 3G/HSPA protocol, as well as any future available mobile communication, such as LTE, newt-generation mobile WiMAX (IEEE802.16m) or next-generation PHS (XGP: eXtended Global Platform).

The main unit 100 or 100a includes the three different types of wireless communication interfaces, i.e., wireless LAN control circuit 174, wireless WAN control circuit 175 and mobile communication control circuit 176 according to the above embodiments. Alternatively, the main unit 100 or 100a may include only one or two of these three different types of wireless communication interfaces or may include four or more different types of wireless communication interfaces according to other embodiments. The main unit 100 or 100a may include a plurality of the same type of wireless communication interfaces. The disclosure is not limited to the wireless LAN or mobile communication but is generally applicable to wireless communication in any suitable wireless communication network. The number of constituents included in the IP address assignment system is not limited to the number described in any of the above embodiments and its modifications. For example, the IP address assignment system may include any number of portable network connection devices.

According to another embodiment, part of the hardware configuration may be replaced by the software configuration, and, in an opposite manner, part of the software configuration may be replaced by the hardware configuration. When part or all of the functions according to the disclosure is implemented by the software configuration, the software (computer programs) may be provided in the form of storage in a computer readable storage medium. The “computer readable storage medium” herein is not limited to portable storage media, such as flexible disks and CD-ROMs but includes internal storage devices, such as various RAMs and ROMs, incorporated in the computer and external storage devices, such as hard drive, attached to the computer. The term “computer readable storage medium” is accordingly used in the wider sense to represent any non-transitory storage medium.

### E. Other Aspects

According to an aspect of an IP address assignment system, the IP address assignment system assigns an IP address to a client is provided. The IP address assignment system includes a plurality of DHCP servers that respectively are able to belong to a first network. Each of DHCP servers respectively includes: an address range storage configured to store an exclusive address range, wherein the exclusive address range represents a range of IP addresses assignable to the client in an entire network address range representing an overall IP address range of the first network, and the exclusive address range does not overlap with an exclusive address range of another DHCP server; an address assignment controller configured to assign an IP address to the client with a lease period when a request for assignment of new IP address is received from the client, wherein the IP address is included in the exclusive address range and the lease period represents a period between an assignment of the IP address and a cancellation of the assignment; and an extension permission controller configured to send a permission for extension to the client, irrespective of whether an assigned IP address is included in the exclusive address range, as long as the assigned IP address is included in the entire network address range, when a request for extension of the lease period with regard to the assigned IP address is received from the client.

In the IP address assignment system according to this aspect, the plurality of DHCP servers have the address range storage that respectively store exclusive address ranges in a non-overlapping manner, and are configured to assign IP addresses included in the respective exclusive address ranges to clients. This advantageously prevents overlapped assignment of IP addresses. Additionally, in this IP address assignment system, when a request for extension of the lease period of the assigned IP address is received from the client having the assigned IP address that is not included in its own exclusive address range of each DHCP server, the DHCP server gives permission for extension as long as the assigned IP address is included in the entire network address range. Even in the event of a failure or removal of one DHCP server, the client can gain extension of the lease period, as long as at least one DHCP server among the plurality of DHCP servers receives the request for extension from the client. This improves the redundancy of the DHCP server function in the IP address assignment system and reduces the request for assignment of new IP address accompanied with expiration of the lease period. This accordingly reduces the processing load of the client and the respective DHCP servers and thereby the loading of the first network (e.g., used bandwidth).

According to another aspect of an IP address assignment system, each of the DHCP servers respectively further includes: a DHCP server function arbiter that arbitrates serving DHCP server function with another DHCP server, wherein as a result of arbitration between the DHCP server function arbiters of the plurality of DHCP servers, only one DHCP server among the plurality of DHCP servers works as a primary server that serves the DHCP server function, while another DHCP server works as a secondary server that does not serve the DHCP server function, in the DHCP server working as the primary server, the address assignment controller executes the assignment of the IP address, and the extension permission controller executes a sending the permission for extension, and in the DHCP server working as the secondary server, the address assignment controller does not execute the assignment of the IP address, and the extension permission controller does not execute the sending the permission for extension.

The IP address assignment system according to this aspect provides only one DHCP server with the DHCP server function and thereby prevents a plurality of different IP addresses from being assigned to the same client by the plurality of DHCP servers. The client is accordingly not required to perform the additional process of selecting one IP address among the assigned plurality of IP addresses and has the reduced processing load. Additionally, this does not require data transmission for assigning IP addresses from the plurality of DHCP servers to the client, thus reducing the load of the respective DHCP servers and the loading of the first network (e.g., used bandwidth).

According to another aspect of an IP address assignment system, the DHCP server function arbiter of each of the DHCP servers arbitrates serving DHCP server function at regular intervals with the DHCP server function arbiter of another DIICP server.

In the IP address assignment system according to this aspect, the DHCP server working as the secondary server can detect the absence of the primary server in the first network due to, for example, failure or removal of the DHCP server working as the primary server, within a short period of time, i.e., at most after the arbitration interval. On detection of the absence of the primary server in the first network, the DHCP server working as the secondary server can be set to work as the primary server, based on the result of arbitration to provide the DHCP server function. It is thus highly probable to shorten the period of time without the primary server in the first network, compared with the configuration without the arbitration with another DHCP server at regular intervals.

According to another aspect of an IP address assignment system, the plurality of DHCP servers include a first DHCP server included in a router and a second DHCP server included in a portable network connection device, when both the router and the portable network connection device belong to the first network, as the result of arbitration between the DHCP server function arbiters of the plurality of DHCP servers, the first DHCP server works as the primary server, while the second DHCP server works as the secondary server, and when the portable network connection device belongs to a second network different from the first network and the router does not belong to the second network, the second DHCP server works as the primary server.

In the IP address assignment system according to this aspect, when the portable network connection device is taken out from the first network, which the router belongs to, and joins the second network, the second DHCP server can be set to work as the primary server in the second network. When the client and the portable network connection device are taken out and join the second network, the client may gain permission for extension from the portable network connection device, in response to the client's request for extension of the lease period with respect to the assigned IP address in the first network. The second DHCP server works as the primary server in the second network. When a new client joins the second network and sends a request for assignment of new IP address, the second DHCP server can assign an IP address to this new client.

According to another aspect of an IP address assignment system, the second DHCP server further includes: an exclusive address range assignment request sender configured to send a request for assignment of the exclusive address range of the second DHCP server to the first DHCP server working as the primary server, when the second DHCP server works as the secondary server, and the first DHCP server further includes: an address range setter configured to receive the request for assignment of the exclusive address range from the second DHCP server and notify the second DHCP server of at least part of a remaining range of the entire network address range other than the exclusive address range for the first DHCP server, as the exclusive address range for the second DHCP server.

In the IP address assignment system according to this aspect, the first DHCP server can totally manage the exclusive address ranges of the respective DHCP servers. This enables assignment of the respective exclusive address ranges in a non-overlapping manner.

According to another aspect of an IP address assignment system, the second DHCP server further includes: a history storage configured to store information on history of the assignment executed by the address assignment controller, when the second DHCP server works as the primary server, wherein the exclusive address range assignment request sender of the second DHCP server specifies a minimum requirement range of the exclusive address range for the second DHCP server, in the request for assignment of the exclusive address range, based on the information on the history of the assignment stored in the history storage.

In the IP address assignment system according to this aspect, the exclusive address range assignment request sender specifies the minimum requirement range based on the information on the history of the assignment, so that the address range setter can set the range including the necessary and sufficient number of IP addresses. This prevents an excessively wide exclusive address range from being set for any of the DHCP servers and thereby reduces the ineffective IP addresses that cannot be assigned to the client.

According to another aspect of an IP address assignment system, a priority relating to serving the DHCP server function is set in advance in each of the DHCP servers, wherein a higher priority is set in the first DHCP server than a priority set in the second DHCP server, the DHCP server function arbiter of each of the DHCP server sends information representing the priority to another DHCP server, each DHCP server works as the primary server when its own priority set in the DHCP server is higher than the priority set in another DHCP server, and each DHCP server works as the secondary server when its own priority set in the DHCP server is lower than the priority set in another DHCP server.

In the IP address assignment system according to this aspect, when both the first DHCP server and the second DHCP server belong to the first network, the first DHCP server can be set to work as the primary server. The router generally has an abundance of hardware resources, such as CPU and memories, compared with the portable network connection device, and is unlikely to affect its packet relay function even when the router works as the primary server to provide the DHCP server function. The portable network connection device, on the other hand, has less hardware resources and is likely to affect its packet relay function when the portable network connection device works as the primary server. Additionally, the user can specify the device to work as the primary server by simply adjusting the priority set in each of the DHCP servers.

According to an aspect of a method of assigning an IP address to a client, the method of assigning an IP address to the client using a plurality of DHCP servers that respectively are able to belong to a first network is provided. The method includes assigning an IP address included in an exclusive address range to the client with a lease period representing a period between an assignment of the IP address and a cancellation of the assignment in each DHCP servers, when a request for assignment of new IP address is received from the client wherein the exclusive address range is stored in a memory of each DHCP server, the exclusive address range represents a range of IP addresses assignable to the client in an entire network address range representing an overall IP address range of the first network, and the exclusive address range does not overlap with an exclusive address range of another DHCP server; and

sending a permission for extension to the client in each DHCP servers, irrespective of whether an assigned IP address is included in the exclusive address range, as long as the assigned IP address is included in the entire network address range, when a request for extension of the lease period with regard to the assigned IP address is received from the client.

In the method according to this aspect, the plurality of DHCP servers respectively store exclusive address ranges in a non-overlapping manner and assign IP addresses included in the respective exclusive address ranges to clients. This advantageously prevents overlapped assignment of IP addresses. Additionally, when a request for extension of the lease period of the assigned IP address is received from the client having the assigned IP address that is not included in its own exclusive address range of each DHCP server, the DHCP server gives permission for extension as long as the assigned IP address is included in the entire network address range. Even in the event of a failure or removal of one DHCP server, the client can gain extension of the lease period, as long as at least one DHCP server among the plurality of DHCP servers receives the request for extension from the client. This improves the redundancy of the DHCP server function and reduces the request for assignment of new IP address accompanied with expiration of the lease period. This accordingly reduces the processing load of the client and the respective DHCP servers and thereby the loading of the first network (e.g., used bandwidth).

According to an aspect of a non-transitory computer readable storage medium, the non-transitory computer readable storage medium having computer readable instructions stored therein that when executed by a plurality of DHCP servers that respectively are able to belong to a first network performs a method of assigning an IP address to a client is provided. The method includes: assigning an IP address included in an exclusive address range to the client with a lease period representing a period between an assignment of the IP address and a cancellation of the assignment in each DHCP servers, when a request for assignment of new IP address is received from the client wherein the exclusive address range is stored in a memory of each DHCP server, the exclusive address range represents a range of IP addresses assignable to the client in an entire network address range representing an overall IP address range of the first network, and the exclusive address range does not overlap with an exclusive address range of another DHCP server; and sending a permission for extension to the client in each DHCP servers, irrespective of whether an assigned IP address is included in the exclusive address range, as long as the assigned IP address is included in the entire network address range, when a request for extension of the lease period with regard to the assigned IP address is received from the client.

In the non-transitory computer readable storage medium according to this aspect, the plurality of DHCP servers respectively store exclusive address ranges in a non-overlapping manner and assign IP addresses included in the respective exclusive address ranges to clients. This advantageously prevents overlapped assignment of IP addresses. Additionally, when a request for extension of the lease period of the assigned IP address is received from the client having the assigned IP address that is not included in its own exclusive address range of each DHCP server, the DHCP server gives permission for extension as long as the assigned IP address is included in the entire network address range. Even in the event of a failure or removal of one DHCP server, the client can gain extension of the lease period, as long as at least one DHCP server among the plurality of DHCP servers receives the request for extension from the client. This improves the redundancy of the DHCP server function and reduces the request for assignment of new IP address accompanied with expiration of the lease period. This accordingly reduces the processing load of the client and the respective DHCP servers and thereby the loading of the first network (e.g., used bandwidth).

The present disclosure may be implemented by a variety of other aspects and applications, for example, a DHCP server, a wireless relay device, a wireless communication system including a wireless relay device, methods of controlling any of these device and system, computer programs to enable the functions of any of these method, device and system, and non-transitory computer readable storage media in which such computer programs are stored.

What is claimed is:

1. An Internet Protocol (IP) address assignment system that assigns an IP address to a client, the system comprising:
a plurality of Dynamic Host Configuration Protocol (DHCP) servers that respectively are able to belong to a first network, wherein each of the DHCP servers include
an address range storage that stores an exclusive address range corresponding to a range of IP addresses assignable to the client in an entire network address range representing an overall IP address range of the first network, wherein the exclusive address range does not overlap with an exclusive address range of another DHCP server;
an address assignment controller that assigns an IP address to the client with a lease period when a request for assignment of new IP address is received from the client, wherein the IP address is included in the exclusive address range and the lease period represents a period between an assignment of the IP address and a cancellation of the assignment; and
an extension permission controller that sends a permission for extension to the client, irrespective of whether an assigned IP address is included in the exclusive address range, as long as the assigned IP address is included in the entire network address range, when a request for extension of the lease period with regard to the assigned IP address is received from the client.

2. The IP address assignment system according to claim 1, wherein
each of the DHCP servers further include
a DHCP server function arbiter that arbitrates serving DHCP server function with another DHCP server, wherein
only one DHCP server among the DHCP servers functions as a primary server that serves the DHCP server function, while another DHCP server functions as a secondary server that does not serve the DHCP server function as a result of arbitration between the DHCP server function arbiters of the DHCP servers,
in the DHCP server functioning as the primary server, the address assignment controller executes the assignment of the IP address, and the extension permission controller executes a sending the permission for extension, and
in the DHCP server functioning as the secondary server, the address assignment controller does not execute the assignment of the IP address, and the extension permission controller does not execute the sending the permission for extension.

3. The IP address assignment system according to claim 2, wherein
the DHCP server function arbiter of each of the DHCP servers arbitrates serving DHCP server function at regular intervals with the DHCP server function arbiter of another DHCP server.

4. The IP address assignment system according to claims 2, wherein
the DHCP servers include a first DHCP server included in a router and a second DHCP server included in a portable network connection device,
the first DHCP server functions as the primary server, while the second DHCP server functions as the secondary server when both the router and the portable network connection device belong to the first network as the result of arbitration between the DHCP server function arbiters of the plurality of DHCP servers, and
the second DHCP server functions as the primary server when the portable network connection device belongs to a second network different from the first network and the router does not belong to the second network.

5. The IP address assignment system according to claim 4, wherein
the second DHCP server further includes
an exclusive address range assignment request sender that sends a request for assignment of the exclusive address range of the second DHCP server to the first DHCP server functioning as the primary server, when the second DHCP server functions as the secondary server, and
the first DHCP server further includes
an address range setter that receives the request for assignment of the exclusive address range from the second DHCP server and notifies the second DHCP server of at least part of a remaining range of the entire network address range other than the exclusive address range for the first DHCP server, as the exclusive address range for the second DHCP server.

6. The IP address assignment system according to claim 5, wherein
the second DHCP server further includes
a history storage that stores information on history of the assignment executed by the address assignment controller when the second DHCP server functions as the primary server, wherein
the exclusive address range assignment request sender of the second DHCP server specifies a minimum requirement range of the exclusive address range for the second DHCP server, in the request for assignment of the exclusive address range, based on the information on the history of the assignment stored in the history storage.

7. The IP address assignment system according to any one of claims 4 to 6, wherein
a priority relating to serving the DHCP server function is set in advance in each of the DHCP servers,
a higher priority is set in the first DHCP server than a priority set in the second DHCP server,
the DHCP server function arbiter of each of the DHCP server sends information representing the priority to another DHCP server,
each DHCP server functions as the primary server when its own priority set in the DHCP server is higher than the priority set in another DHCP server, and
each DHCP server functions as the secondary server when its own priority set in the DHCP server is lower than the priority set in another DHCP server.

8. A Dynamic Host Configuration Protocol (DHCP) server assigning an Internet Protocol (IP) address to a client and being able to belong to a first network, the DHCP server comprising:
an address range storage that stores an exclusive address range corresponding to a range of IP addresses assignable to the client in an entire network address range representing an overall IP address range of the first network, wherein the exclusive address range does not overlap with an exclusive address range of another DHCP server;
an address assignment controller that assigns an IP address to the client with a lease period when a request for assignment of new IP address is received from the client, wherein the IP address is included in the exclusive address range and the lease period represents a period between an assignment of the IP address and a cancellation of the assignment; and
an extension permission controller that sends a permission for extension to the client, irrespective of whether an assigned IP address is included in the exclusive address range, as long as the assigned IP address is included in the entire network address range, when a request for extension of the lease period with regard to the assigned IP address is received from the client.

9. The DHCP server according to claim 8, wherein
the DHCP server further comprises a DHCP server function arbiter that arbitrates serving DHCP server function with another DHCP server,
only one DHCP server between the DHCP server and the another DHCP server functions as a primary server that serves the DHCP server function, while the other DHCP server functions as a secondary server that does not serve the DHCP server function as a result of arbitration between the DHCP server function arbiters and the another DHCP server,
the address assignment controller executes the assignment of the IP address when the DHCP server functions as the primary server, and does not execute the assignment of the IP address when the DHCP server functions as the secondary server,
the extension permission controller executes a sending the permission for extension when the DHCP server functions as the primary server, and does not execute the sending the permission for extension when the DHCP server functions as the secondary server.

10. The DHCP server according to claim 9, wherein
the DHCP server function arbiter arbitrates serving DHCP server function at regular intervals with the another DHCP server.

11. The DHCP server according to claim 9, wherein
the another DHCP server includes a first DHCP server included in a router,
the DHCP server includes a second DHCP server included in a portable network connection device,
the first DHCP server functions as the primary server, while the second DHCP server functions as the secondary server when both the router and the portable network connection device belong to the first network as the result of arbitration between the DHCP server function arbiter and the another DHCP server, and
the second DHCP server functions as the primary server when the portable network connection device belongs to a second network different from the first network and the router does not belong to the second network.

12. The DHCP server according to claim 11, wherein
the second DHCP server further includes
an exclusive address range assignment request sender that sends a request for assignment of the exclusive address range of the second DHCP server to the first DHCP server functioning as the primary server, when the second DHCP server functions as the secondary server, and
the first DHCP server further includes
an address range setter that receives the request for assignment of the exclusive address range from the second DHCP server and notifies the second DHCP server of at least part of a remaining range of the entire network address range other than the exclusive address range for the first DHCP server, as the exclusive address range for the second DHCP server.

13. The DHCP server according to claim 12, wherein
the second DHCP server further includes
a history storage that stores information on history of the assignment executed by the address assignment controller when the second DHCP server functions as the primary server, wherein
the exclusive address range assignment request sender of the second DHCP server specifies a minimum requirement range of the exclusive address range for the second DHCP server, in the request for assignment of the exclusive address range, based on the information on the history of the assignment stored in the history storage.

14. The DHCP server according to claim 11, wherein
a priority relating to serving the DHCP server function is set in advance in the DHCP server and the another DHCP server,
a higher priority is set in the first DHCP server than a priority set in the second DHCP server,
the DHCP server function arbiter sends information representing the priority to the another DHCP server,
the DHCP server functions as the primary server when its own priority set in the DHCP server is higher than the priority set in the another DHCP server, and
the DHCP server functions as the secondary server when its own priority set in the DHCP server is lower than the priority set in the another DHCP server.

15. A method of assigning an Internet Protocol (IP) address to a client using a plurality of Dynamic Host Configuration Protocol (DHCP) servers that respectively are able to belong to a first network, the method comprising:
assigning an IP address included in an exclusive address range to the client with a lease period representing a period between an assignment of the IP address and a cancellation of the assignment in each DHCP servers, when a request for assignment of new IP address is received from the client wherein the exclusive address range is stored in a memory of each DHCP server, the exclusive address range corresponding to a range of IP addresses assignable to the client in an entire network address range representing an overall IP address range of the first network, and the exclusive address range does not overlap with an exclusive address range of another DHCP server; and
sending a permission for extension to the client from each DHCP server, irrespective of whether an assigned IP address is included in the exclusive address range, as long as the assigned IP address is included in the entire network address range, when a request for extension of the lease period with regard to the assigned IP address is received from the client.

16. A method of assigning an Internet Protocol (IP) address to a client using a Dynamic Host Configuration Protocol (DHCP) server that is able to belong to a first network, the method comprising:
assigning an IP address included in an exclusive address range to the client with a lease period representing a period between an assignment of the IP address and a cancellation of the assignment in a DHCP server, when a request for assignment of new IP address is received from the client, wherein the exclusive address range is stored in a memory of the DHCP server, the exclusive address range corresponding to a range of IP addresses assignable to the client in an entire network address range representing an overall IP address range of the first network, and the exclusive address range does not overlap with an exclusive address range of another DHCP server; and
sending a permission for extension to the client in a DHCP server, irrespective of whether an assigned IP address is included in the exclusive address range, as long as the assigned IP address is included in the entire network address range, when a request for extension of the lease period with regard to the assigned IP address is received from the client.
